(19) United States
(12) Patent Application Publication
(10) Pub. No.: US 2025/0219798 A1
(43) Pub. Date: Jul. 3, 2025

(54) METHOD AND APPARATUS FOR EVENT TRIGGERED REPORTING IN A WIRELESS COMMUNICATION SYSTEM

(71) Applicant: ASUS Technology Licensing Inc., Taipei City (TW)

(72) Inventors: Chun-Wei Huang, Taipei City (TW); Yu-Hsuan Guo, Taipei City (TW); Yi-Hsuan Kung, Taipei City (TW)

(21) Appl. No.: 19/000,010

(22) Filed: Dec. 23, 2024

Related U.S. Application Data
(60) Provisional application No. 63/616,481, filed on Dec. 29, 2023.

(51) Int. Cl. H04L 5/00; H04B 7/06

(52) U.S. Cl. CPC H04L 5/0057; H04B 7/0626

(57) ABSTRACT

Methods, systems, and apparatuses are provided for event triggered reporting in a wireless communication system, wherein a method of a User Equipment (UE) comprises triggering a first report in response to a first condition being fulfilled, transmitting a request in response to the triggering of the first report, receiving a first Downlink Control Information (DCI) scheduling a first Physical Uplink Shared Channel (PUSCH), determining whether to transmit the first report on the first PUSCH based on whether a Channel State Information (CSI) request field in the first DCI indicates a first code-point which is associated with a first CSI triggering state associated with a first CSI report configuration for the first report, and transmitting the first report on the first PUSCH if the CSI request field in the first DCI indicates the first code-point.

### CROSS-REFERENCE TO RELATED APPLICATIONS

The present application claims priority to and the benefit of U.S. Provisional Patent Application Ser. No. 63/616,481, filed Dec. 29, 2023, which is fully incorporated herein by reference.

### FIELD

This disclosure generally relates to wireless communication networks and, more particularly, to a method and apparatus for event triggered reporting in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for event triggered reporting in a wireless communication system. In various embodiments, a method of a User Equipment (UE) comprises triggering a first report in response to a first condition being fulfilled, transmitting a request in response to the triggering of the first report, receiving a first Downlink Control Information (DCI) scheduling a first Physical Uplink Shared Channel (PUSCH), determining whether to transmit the first report on the first PUSCH based on whether a Channel State Information (CSI) request field in the first DCI indicates a first code-point which is associated with a first CSI triggering state associated with a first CSI report configuration for the first report, and transmitting the first report on the first PUSCH if the CSI request field in the first DCI indicates the first code-point.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5A is a reproduction of Fig. 3-1: Two deployment scenarios for M-TRP CJT, (a) Intra-site M-TRP CJT, from R1-2204369.

FIG. 5B is a reproduction of Fig. 3-1: Two deployment scenarios for M-TRP CJT, (b) Inter-site M-TRP CJT, from R1-2204369.

FIG. 6 is a reproduction of Figure 6.1.3.13-1: Aperiodic CSI Trigger State Subselection MAC CE, from 3GPP RS 38.321 h60.

FIG. 7 is a reproduction of Figure 6.1.3.47-1: Unified TCI state activation/deactivation MAC CE, from 3GPP RS 38.321 h60.

FIG. 8 is a flow diagram of a method of a UE in a wireless communication system comprises receiving one or more specific (reporting) configurations associated with UE-initiated reporting, wherein one or more specific configurations are associated with a parameter for configuring a time domain behavior as UE-initiated, when the UE attempts to transmit more than one reporting in one time instance or TTI, the UE prioritizes to transmit reporting based on a priority value, and transmitting one or more reportings in the one time instance or the TTI to a network node, in accordance with embodiments of the present invention.

FIG. 9 is a flow diagram of a method of UE in a wireless communication system comprises triggering one or more reportings, preferably which could be beam reporting or CJT calibration reporting, based on or in response to that one or more triggerings is satisfied, determining whether to trigger SR based on whether there is a UL resource which is available for new transmission comprising the one or more triggered reportings, and transmitting the one or more reportings on a UL resource in one instance or TTI, in accordance with embodiments of the present invention.

FIG. 10 is a flow diagram of a method of a UE in a wireless communication system comprises triggering a first report in response to a first condition being fulfilled, transmitting a request in response to the triggering of the first report, receiving a first DCI scheduling a first PUSCH, determining whether to transmit the first report on the first PUSCH based on whether a CSI request field in the first DCI indicates a first code-point which is associated with a first CSI triggering state associated with a first CSI report configuration for the first report, and transmitting the first report on the first PUSCH if the CSI request field in the first DCI indicates the first code-point, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-232915, Proposal for Rel-19 MIMO Objectives; [2]3GPP TS 38.214 i00; [3]R1-2204369, DOCOMO; [4]3GPP TS 38.211 i00; [5]3GPP TS 38.212 i00; [6]3GPP TS 38.331 h60; [7]3GPP TS 38.321 h50; and [8]3GPP TS 38.213 h60. The standards and documents listed above are hereby expressly and fully incorporated herein by reference in their entirety.

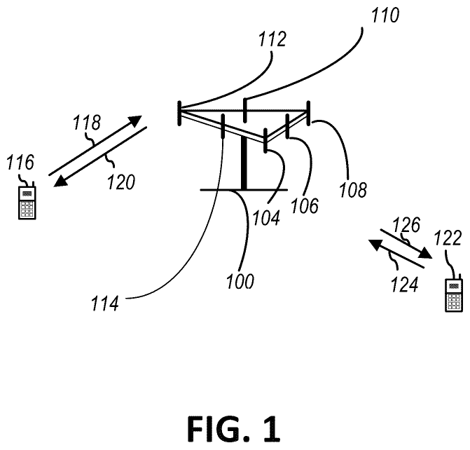

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

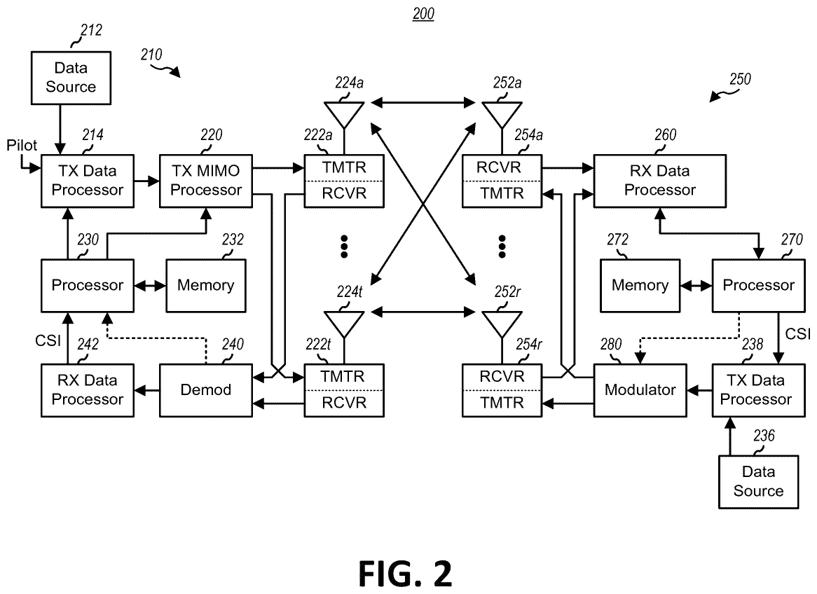

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

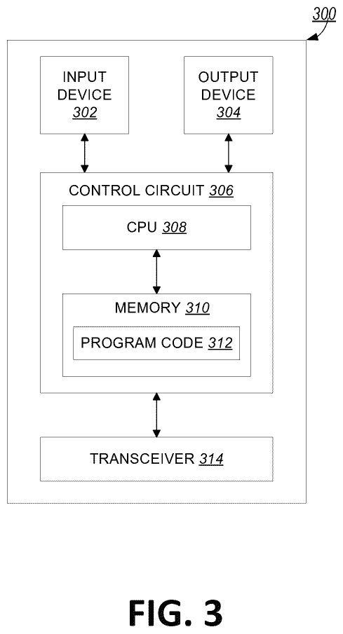

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

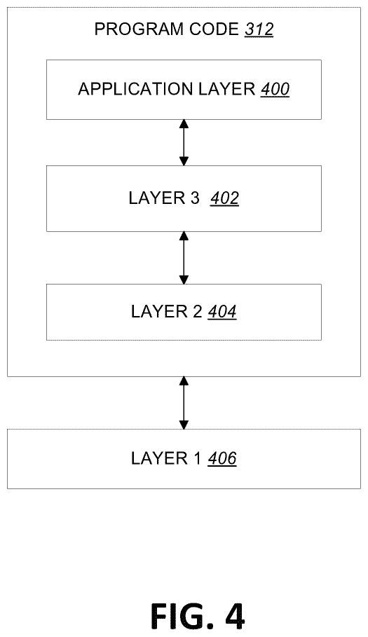

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In [1] RP-232915, some discussion points related to the need of non-synchronization for coherence joint transmission is provided.

### 2. Proposed Objectives: RANI

1. Specify enhancement to facilitate UE-initiated/event-driven beam management for reducing overhead and/or latency, assuming the unified TCI while leveraging (as much as possible) legacy CSI measurement and reporting configuration frameworks, targeting FR2 and sTRP with intra- and inter-cell beam management
   a. UL signaling content(s) for UE-initiated/event-driven beam reporting facilitating fast beam switching
   b. UL signaling medium/container considering the UE-initiated/event-driven nature of the UL transmission, designed primarily for the purpose of beam reporting
2. Specify UE reporting enhancement for CJT deployments under non-ideal synchronization and backhaul, targeting FRI, both FDD and TDD
   a. Inter-TRP time misalignment and frequency/phase offset measurement and reporting, assuming legacy CSI-RS design, with stand-alone aperiodic reporting on PUSCH

### Acronyms

sTRP: single TRP (transmit-receive point)
mTRP: multiple TRP (transmit-receive point)
CJT: coherent joint transmission
DU: distributed unit
CRI: CSI-RS resource indicator

### 3. Proposed Justification

In legacy beam management procedures, the network may configure/activate frequent periodic or semi-persistent beam reporting (e.g., N best beams and corresponding L1-RSRPs) or triggers frequent aperiodic beam reporting to timely acquire the best/preferred beam for data/control transmissions. However, this clearly results in large UL reporting overhead and control signaling overhead. At the same time, if less frequent beam reporting is configured, the network could not always acquire ‘best/preferred’ beam(s) as the beam reporting by the UE may be outdated, thus leading to performance degradation. Given that UE has better and more-timely knowledge of beam quality changes, UE-initiated beam reporting procedure can lead to more timely beam reports yet with reduced reporting overhead. Under such a procedure, if the UE determines that e.g., current beam(s) quality becomes poor, UE can trigger beam reporting without the network needing to configure or trigger frequent reporting.

. . .

The coherent joint transmission (CJT) offers downlink spectral efficiency and coverage gain. In Rel-18, Type-II CSI has been enhanced to accommodate CJT assuming ideal synchronization and backhaul. Scenarios such as inter-site CJT and a base station equipped with distributed remote radio heads (RRHs) require additional delay and phase/frequency calibration. For TDD, additional inter-TRP DL/UL calibration across TRPs is also beneficial to ensure proper DL/UL reciprocity holds. As the UE possesses more knowledge on DL channel condition in both FDD and TDD, the need for inter-TRP calibration reporting measured from CSI-RS is evident not only to expand the deployment scenarios, but also to offer additional robustness to CJT operation.

. . .

In [2]3GPP TS 38.214 i00, the following is provided.

### 5.1.5 Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE can be configured with a list of up to 128 TCI-State configurations, within the higher layer parameter dl-OrJointTCI-StateList in PDSCH-Config for providing a reference signal for the quasi co-location for DM-RS of PDSCH and DM-RS of PDCCH in a BWP/CC, for CSI-RS, and to provide a reference, if applicable, for determining UL TX spatial filter for dynamic-grant and configured-grant based PUSCH and PUCCH resource in a BWP/CC, and SRS.

If the TCI-State or TCI-UL-State configurations are absent in a BWP of the CC, the UE can apply the TCI-State or TCI-UL-State configurations from a reference BWP of a reference CC.

The UE receives an activation command, as described in clause 6.1.3.xx of [10, TS 38.321], 6.1.3.47 of [10, TS 38.321] or 6.1.4.xx of [10, TS 38.321], used to map up to 8 TCI states and/or pairs of TCI states, with one TCI state for DL channels/signals and/or one TCI state for UL channels/signals to the codepoints of the DCI field ‘Transmission Configuration Indication’ for one or for a set of CCs/DL BWPs, [and/] or up to 8 sets of TCI states, where each set is comprised of up to two TCI state(s) for DL and UL signals/channels, or up to two TCI state(s) for DL channels/signals and up to two TCI state(s) for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied as described in [11, TS 38.133].

When the bwp-id or cell for QCL-TypeA/D source RS in a QCL-Info of the TCI state is not configured, the UE assumes that QCL-TypeA/D source RS is configured in the CC/DL BWP where TCI state applies.

If a UE receives a higher layer configuration of dl-OrJointTCI-StateList with a single TCI-State, that can be used as an indicated TCI state, the UE obtains the QCL assumptions from the configured TCI state for DM-RS of PDSCH and DM-RS of PDCCH, and the CSI-RS applying the indicated TCI state.

If a UE receives a higher layer configuration of dl-OrJointTCI-StateList with a single TCI-State or ul-TCI-StateList with a single TCI-UL-State, that can be used as an indicated TCI state, the UE determines an UL TX spatial filter, if applicable, from the configured TCI state for dynamic-grant and configured-grant based PUSCH and PUCCH, and SRS applying the indicated TCI state.

When a UE configured with dl-OrJointTCI-StateList would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if the indicated TCI State(s) is/are different from the previously indicated one(s), the indicated TCI-State(s) and/or TCI-UL-State(s) should be applied starting from the first slot that is at least beamAppTime symbols after the last symbol of the PUCCH or the PUSCH. The first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 Tel states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ}+2^{μ}/2^{μ}^{_{K}}_{mac}, k_{mac} where μ is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling a PDSCH, the UE assumes that the TCI field is present in the DCI format 1_1 or format 1_3 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET.

For a periodic CSI-RS resource in an NZP-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block where SS/PBCH block may have a PCI different from the PCI of the serving cell. The UE can assume center frequency, SCS, SFN offset are the same for SS/PBCH block from the serving cell and SS/PBCH block having a PCI different from the serving cell, or
‘typeC’ with an SS/PBCH block and, when applicable,‘typeD’ with a CSI-RS resource in an NZP-CSI-RS-ResourceSet configured with higher layer parameter repetition, where SS/PBCH block may have a PCI different from the PCI of the serving cell. The UE can assume center frequency, SCS, SFN offset are the same for SS/PBCH block from the serving cell and SS/PBCH block having a PCI different from the serving cell.

For periodic/semi-persistent CSI-RS, if the UE is configured with dl-OrJointTCI-StateList, the UE can assume that the indicated TCI-State is not applied.

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, where SS/PBCH block may have a PCI different from the PCI of the serving cell. The UE can assume center frequency, SCS, SFN offset are the same for SS/PBCH block from the serving cell and SS/PBCH block having a PCI different from the serving cell, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeC’ with an SS/PBCH block and, when applicable, ‘typeD’ with the same SS/PBCH block, the reference RS may additionally be an SS/PBCH block having a PCI different from the PCI of the serving cell. The UE can assume center frequency, SCS, SFN offset are the same for SS/PBCH block from the serving cell and SS/PBCH block having a PCI different from the serving cell.

For the DM-RS of PDCCH, if the UE is not configured with dl-OrJointTCI-StateList, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

### 5.1.6 UE Procedure for Receiving Reference Signals

### 5.1.6.1 CSI-RS Reception Procedure

The CSI-RS defined in Clause 7.4.1.5 of [4, TS 38.211], may be used for time/frequency tracking, CSI computation, L1-RSRP computation, L1-SINR computation, mobility, and tracking during fast SCell activation.

For a CSI-RS resource associated with a NZP-CSI-RS-ResourceSet with the higher layer parameter repetition set to ‘on’, the UE shall not expect to be configured with CSI-RS over the symbols during which the UE is also configured to monitor the CORESET, while for other NZP-CSI-RS-ResourceSet configurations, if the UE is configured with a CSI-RS resource and a search space set associated with a CORESET in the same OFDM symbol(s), the UE may assume that the CSI-RS and a PDCCH DM-RS transmitted in all the search space sets associated with CORESET are quasi co-located with ‘typeD’, if ‘typeD’ is applicable. If the CORESET is activated with two TCI states, UE may assume that the first TCI state of the CORESET as the default QCL assumption for the CSI-RS. This also applies to the case when CSI-RS and the CORESET are in different intra-band component carriers, if ‘typeD’ is applicable. Furthermore, the UE shall not expect to be configured with the CSI-RS in PRBs that overlap those of the CORESET in the OFDM symbols occupied by the search space set(s).

The UE is not expected to receive CSI-RS and SIB1 message in the overlapping PRBs in the OFDM symbols where SIB1 is transmitted.

### 5.1.6.1.1 CSI-RS for Tracking

A UE in RRC connected mode is expected to receive the higher layer UE specific configuration of a NZP-CSI-RS-ResourceSet configured with higher layer parameter trs-Info.

For a NZP-CSI-RS-ResourceSet configured with the higher layer parameter trs-Info, the UE shall assume the antenna port with the same port index of the configured NZP CSI-RS resources in the NZP-CSI-RS-ResourceSet is the same.
For frequency range 1, the UE may be configured with one or more NZP CSI-RS set(s), where a NZP-CSI-RS-ResourceSet consists of four periodic NZP CSI-RS resources in two consecutive slots with two periodic NZP CSI-RS resources in each slot. If no two consecutive slots are indicated as downlink slots by tdd-UL-DL-ConfigurationCommon or tdd-UL-DL-ConfigDedicated, then the UE may be configured with one or more NZP CSI-RS set(s), where a NZP-CSI-RS-ResourceSet consists of two periodic NZP CSI-RS resources in one slot.
For frequency range 2 the UE may be configured with one or more NZP CSI-RS set(s), where a NZP-CSI-RS-ResourceSet consists of two periodic CSI-RS resources in one slot or with a NZP-CSI-RS-ResourceSet of four periodic NZP CSI-RS resources in two consecutive slots with two periodic NZP CSI-RS resources in each slot.

A UE configured with NZP-CSI-RS-ResourceSet(s) configured with higher layer parameter trs-Info may have the CSI-RS resources configured as:
Periodic, with the CSI-RS resources in the NZP-CSI-RS-ResourceSet configured with same periodicity, bandwidth and subcarrier location.
Periodic CSI-RS resource in one set and aperiodic CSI-RS resources in a second set, with the aperiodic CSI-RS and periodic CSI-RS resource having the same bandwidth (with same RB location) and the aperiodic CSI-RS being configured with qcl-Type set to ‘typeA’ and ‘typeD’, where applicable, with the periodic CSI-RS resources. For frequency range 2, the UE does not expect that the scheduling offset between the last symbol of the PDCCH carrying the triggering DCI and the first symbol of the aperiodic CSI-RS resources is smaller than beamSwitchTiming+d·2^{μ}^{_{CSIRS}}/2^{μ}^{_{PDCCH}} in CSI-RS symbols, where beamSwitchTiming is UE reported value defined in [13, TS 38.306], the reported value is one of the values of {14, 28, 48}·2^{max(0,μ}^{_{CSIRS}}⁻³⁾, and the beam switching timing delay d is defined in Table 5.2.1.5.1a-1 if μ_{PDCCH}<μ_{CSIRS}, else d is zero. The UE shall expect that the periodic CSI-RS resource set and aperiodic CSI-RS resource set are configured with the same number of CSI-RS resources and with the same number of CSI-RS resources in a slot. For the aperiodic CSI-RS resource set if triggered, and if the associated periodic CSI-RS resource set is configured with four periodic CSI-RS resources with two consecutive slots with two periodic CSI-RS resources in each slot, the higher layer parameter aperiodicTriggeringOffset indicates the triggering offset for the first slot for the first two CSI-RS resources in the set.

. . .

### 5.1.6.1.2 CSI-RS for L1-RSRP and L1-SINR Computation

If a UE is configured with a NZP-CSI-RS-ResourceSet configured with the higher layer parameter repetition set to ‘on’, the UE may assume that the CSI-RS resources, described in Clause 5.2.2.3.1, within the NZP-CSI-RS-ResourceSet are transmitted with the same downlink spatial domain transmission filter, where the CSI-RS resources in the NZP-CSI-RS-ResourceSet are transmitted in different OFDM symbols. If repetition is set to ‘off’, the UE shall not assume that the CSI-RS resources within the NZP-CSI-RS-ResourceSet are transmitted with the same downlink spatial domain transmission filter.

If the UE is configured with a CSI-ReportConfig with reportQuantity set to ‘cri-RSRP’, ‘cri-SINR’ or ‘none’ and if the CSI-ResourceConfig for channel measurement (higher layer parameter resourcesForChannelMeasurement) contains a NZP-CSI-RS-ResourceSet that is configured with the higher layer parameter repetition and without the higher layer parameter trs-Info, the UE can only be configured with the same number (1 or 2) of ports with the higher layer parameter nrofPorts for all CSI-RS resources within the set. If the UE is configured with the CSI-RS resource in the same OFDM symbol(s) as an SS/PBCH block, the UE may assume that the CSI-RS and the SS/PBCH block are quasi co-located with ‘typeD’ if ‘typeD’ is applicable. Furthermore, the UE shall not expect to be configured with the CSI-RS in PRBs that overlap with those of the SS/PBCH block, and the UE shall expect that the same subcarrier spacing is used for both the CSI-RS and the SS/PBCH block.

. . .

### 5.2 UE Procedure for Reporting Channel State Information (CSI)

### 5.2.1 Channel State Information Framework

The procedures on aperiodic CSI reporting described in this clause assume that the CSI reporting is triggered by DCI format 0_1, but they equally apply to CSI reporting triggered by DCI format 0_2, by applying the higher layer parameter reportTriggerSizeDCI-0-2 instead of reportTriggerSize. The procedures on aperiodic CSI reporting described in this clause assume that the CSI reporting is triggered by DCI format 0_1, but they equally apply to CSI reporting triggered by DCI format 0_3.

The time and frequency resources that can be used by the UE to report CSI are controlled by the gNB. CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), LI-RSRP, LI-SINR, CapabilityIndex or time-domain channel properties (TDCP).

For CQI, PMI, CRI, SSBRI, LI, RI, L1-RSRP, L1-SINR, CapabilityIndex, TDCP a UE is configured by higher layers with N≥1 CSI-ReportConfig Reporting Settings and/or [X≥1 LTM-CSI-ReportConfig Reporting Settings], M≥1 CSI-ResourceConfig Resource Settings and/or [Y≥1 LTM-CSI-ResourceConfig Resource Settings], and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs [and/or LTM-CSI-ReportConfigs]indicating the Resource Set IDs for channel and optionally for interference [where a Resource Set for interference can only be present for a Report Setting given by a CSI-ReportConfig] and a trigger state additionally contains one or more [csi-ReportSubConfigID] if the associated CSI-ReportConfig configured with a list of sub-configurations, as described in Clause 5.2.1.1. Each trigger state in CSI-SemiPersistentOnPUSCH-TriggerStateList contains one associated CSI-ReportConfig [or LTM-CSI-ReportConfig], and a trigger state additionally contain one or more [csi-ReportSubConfigID] if the associated CSI-ReportConfig is configured with a list of sub-configurations, as described in Clause 5.2.1.1.

### 5.2.1.1 Reporting Settings

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, SSBRI (SSB Resource Indicator), CapabilityIndex and TDCP.

Each Reporting Setting [LTM-CSI-ReportConfig] is associated with a [LTM-CSI-ResourceConfig] for channel measurement and contains the parameters(s) for time-domain behavior, the number of cells and the number of reference signals per cell provided by [noOfReportedCells], and [noOfReportedRSPerCell], respectively, comprising LI measurement results associated with current SpCell by SpCellInclusion.

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, L1-SINR-related, CapabilityIndex-related or TDCP-related quantities to report. The reportFreqConfiguration indicates the reporting granularity in the frequency domain, including the CSI reporting band and if PMI/CQI reporting is wideband or sub-band. . . . The CSI-ReportConfig can also contain CodebookConfig, which contains configuration parameters for Type-I, Type II, Enhanced Type II CSI, Further Enhanced Type II Port Selection, Enhanced Type II for coherent joint transmission (CJT), Further Enhanced Type II Port Selection for CJT, Enhanced Type II for predicted PMI, or Further Enhanced Type II Port Selection for predicted PMI including codebook subset restriction when applicable, and configurations of group-based reporting. A UE is not expected to be configured with a CSI report setting associated with a dormant DL BWP if the reportConfigType is set to ‘aperiodic’. A CSI-ReportConfig can contain a list of sub-configurations, provided by the higher layer parameter [csi-ReportSubConfigList], where each sub-configuration is identified by [csi-ReportSubConfigID] and corresponds to a list of one or more CSI-RS resources or corresponds to a CSI-RS antenna port subset, and/or corresponds to a power offset for PDSCH relative to CSI-RS. A UE is not expected to be configured with a CSI-ReportConfig that contains a mix of sub-configuration(s) each corresponding to a list of one or more CSI-RS resources and some other sub-configuration(s) each corresponding to CSI-RS antenna port subset.

### 5.2.1.2 Resource Settings

Each CSI Resource Setting CSI-ResourceConfig contains a configuration of a list of S≥1 CSI Resource Sets (given by higher layer parameter csi-RS-ResourceSetList), where the list is comprised of references to either or both of NZP CSI-RS resource set(s) and SS/PBCH block set(s) or the list is comprised of references to CSI-IM resource set(s). Each CSI Resource Setting is located in the DL BWP identified by the higher layer parameter BWP-id, and all CSI Resource Settings linked to a CSI Report Setting have the same DL BWP.

The time domain behavior of the CSI-RS resources within a CSI Resource Setting are indicated by the higher layer parameter resourceType and can be set to aperiodic, periodic, or semi-persistent. For periodic and semi-persistent CSI Resource Settings, when the UE is configured with groupBasedBeamReporting-r17 or groupBasedBeamReporting-v18, the number of CSI Resource Sets configured is S=2, otherwise the number of CSI-RS Resource Sets configured is limited to S=1, except for periodic CSI Resource Settings, when the UE is configured with TDCP reporting, for which the number of CSI-RS Resource Sets in the CSI Resource Setting for channel measurement is K_{TRS} ∈{1,2,3} and all the CSI-RS Resource Sets are configured with the higher layer parameter trs-Info. For periodic and semi-persistent CSI Resource Settings, the configured periodicity and slot offset is given in the numerology of its associated DL BWP, as given by BWP-id. When a UE is configured with multiple CSI-ResourceConfigs consisting the same NZP CSI-RS resource ID, the same time domain behavior shall be configured for the CSI-ResourceConfigs. When a UE is configured with multiple CSI-ResourceConfigs consisting the same CSI-IM resource ID, the same time-domain behavior shall be configured for the CSI-ResourceConfigs. All CSI Resource Settings linked to a CSI Report Setting shall have the same time domain behavior.

For TDCP measurement, one aperiodic or periodic CSI Resource Setting is configured, and the Resource Setting is for channel measurement on CSI-RS for tracking.

Each LTM CSI Resource Setting [LTM-CSI-ResourceConfig]contains configuration of a [LTM-CSI-SSB-ResourceSet]which comprises of a list of Z≥1 SS/PBCH blocks indices (given by [LTM-csi-SSB-ResourceList]) and a list of Z [PCI indices](given by [LTM-CandidateId-list]) referring to cells associated with the SS/PBCH block indices. The UE determines the time domain behavior of a SS/PBCH block from ssb-Periodicity and ssb-PositionsInBurst and the frequency domain behavior of a SS/PBCH block is determined by the higher layer parameters subcarrierspacing, ssbFrequency.

### 5.2.1.4 Reporting Configurations

The UE shall calculate CSI parameters (if reported) assuming the following dependencies between CSI parameters (if reported)
LI shall be calculated conditioned on the reported CQI, PMI, RI and CRI
CQI shall be calculated conditioned on the reported PMI, RI and CRI
PMI shall be calculated conditioned on the reported RI and CRI
RI shall be calculated conditioned on the reported CRI.

The Reporting configuration for CSI can be aperiodic (using PUSCH), periodic (using PUCCH) or semi-persistent (using PUCCH, and DCI activated PUSCH). The CSI-RS Resources can be periodic, semi-persistent, or aperiodic. Table 5.2.1.4-1 shows the supported combinations of CSI Reporting configurations and CSI-RS Resource configurations and how the CSI Reporting is triggered for each CSI-RS Resource configuration. Periodic CSI-RS is configured by higher layers. Semi-persistent CSI-RS is activated and deactivated as described in Clause 5.2.1.5.2. Aperiodic CSI-RS is configured and triggered/activated as described in Clause 5.2.1.5.1.

TABLE 5.2.1.4-1
Triggering/Activation of CSI Reporting for the possible CSI-RS Configurations.
Semi-Persistent CSI

| | Periodic CSI | Semi-Persistent CSI | Aperiodic CSI |
|---|---|---|---|
| CSI-RS Configuration | Reporting | Reporting | Reporting |
| Periodic CSI-RS | No dynamic | For reporting on PUCCH, | Triggered by DCI; |
| | triggering/activation | the UE receives an | additionally, subselection |
| | | activation command, as | indication as described in |
| | | described in clause | clause 6.1.3.13 of [10, TS |
| | | 6.1.3.16 of [10, TS 38.321]; | 38.321] possible as defined |
| | | for reporting on PUSCH, | in Clause 5.2.1.5.1. |
| | | the UE receives triggering | |
| | | on DCI | |
| Semi-Persistent CSI-RS | Not Supported | For reporting on PUCCH, | Triggered by DCI; |
| | | the UE receives an | additionally, subselection |
| | | activation command, as | indication as described in |
| | | described in clause | clause 6.1.3.13 of [10, TS |
| | | 6.1.3.16 of [10, TS 38.321]; | 38.321] possible as defined |
| | | for reporting on PUSCH, | in Clause 5.2.1.5.1. |
| | | the UE receives triggering | |
| | | on DCI | |
| Aperiodic CSI-RS | Not Supported | Not Supported | Triggered by DCI; |
| | | | additionally, subselection |
| | | | indication as described in |
| | | | clause 6.1.3.13 of [10, TS |
| | | | 38.321] possible as defined |
| | | | in Clause 5.2.1.5.1. |

When the UE is configured with higher layer parameter NZP-CSI-RS-ResourceSet and when the higher layer parameter repetition is set to ‘off’, the UE shall determine a CRI from the supported set of CRI values as defined in Clause 6.3.1.1.2 of [5, TS 38.212] and report the number in each CRI report. When the higher layer parameter repetition for a CSI-RS Resource Set for channel measurement is set to ‘on’, CRI for the CSI-RS Resource Set for channel measurement is not reported. CRI reporting is not supported when the higher layer parameter codebookType is set to ‘typeII’, ‘typeII-PortSelection’, ‘typeII-r16’, ‘typeII-PortSelection-r16’, ‘typeII-PortSelection-r17’, ‘typeII-CJT-r18’, ‘typeII-CJT-PortSelection-r18’, ‘typeII-Doppler-r18’ or ‘typeII-Doppler-PortSelection-r18’.

For a periodic or semi-persistent CSI report on PUCCH, the periodicity T_{CSI} (measured in slots) and the slot offset T_{offset} are configured by the higher layer parameter reportSlotConfig. Unless specified otherwise, the UE shall transmit the CSI report in frames with SFN n_{f} and slot number within the frame n_{s,f}^{μ} satisfying

$$( {N}_{slot}^{frame , μ} {n}_{f} + {n}_{s , f}^{μ} - {T}_{offset} ) mod {T}_{CSI} = 0$$

where μ is the SCS configuration of the UL BWP the CSI report is transmitted on.

For a semi-persistent CSI report on PUSCH, the periodicity T_{CSI} (measured in slots) is configured by the higher layer parameter reportSlotConfig. Unless specified otherwise, the UE shall transmit the CSI report in frames with SFN n_{f} and slot number within the frame n_{s,f}^{μ} satisfying

$$( {N}_{slot}^{frame , μ} ( {n}_{f} - {n}_{f}^{start} ) + {n}_{s , f}^{μ} - {n}_{s , f}^{start} ) mod {T}_{CSI} = 0$$

where n_{f}^{start} and n_{s,f}^{start} are the SFN and slot number within the frame respectively of the initial semi-persistent PUSCH transmission according to the activating DCI.

For a semi-persistent or aperiodic CSI report on PUSCH, the allowed slot offsets are configured by the following higher layer parameters:
if triggered/activated by DCI format 0_2 and the higher layer parameter reportSlotOffsetListDCI-0-2 or reportSlotOffsetListDCI-0-2-r17 is configured, the allowed slot offsets are configured by reportSlotOffsetListDCI-0-2 or reportSlotOffsetListDCI-0-2-r17, and
if triggered/activated by DCI format 0_1 or 0_3 and the higher layer parameter reportSlotOffsetListDCI-0-1 or reportSlotOffsetListDCI-0-1-r17 is configured, the allowed slot offsets are configured by reportSlotOffsetListDCI-0-1 or reportSlotOffsetListDCI-0-1-r17, and
otherwise, the allowed slot offsets are configured by the higher layer parameter reportSlotOffsetList or reportSlotOffsetList-r17.

### 5.2.1.4.1 Resource Setting Configuration

For aperiodic CSI, and for aperiodic CSI resource settings, each trigger state configured using the higher layer parameter CSI-AperiodicTriggerState is associated with one or multiple CSI-ReportConfig where the CSI-ReportConfig configured with groupBasedBeamReporting-r17 or groupBasedBeamReporting-v18 is associated with resourcesForChannel and resourcesForChannel2, which correspond to first and second resource sets, respectively, for L1-RSRP measurement.

For a UE configured with [LTM-CSI-ReportConfig], the aperiodic, semi-persistent or periodic CSI are associated with one Resource Setting given by [LTM-resourcesForChannelMeasurement] for L1-RSRP measurement.

A subset of resources, where a subset contains one or more resources, of a NZP CSI-RS Resource Set for channel measurement corresponds to a sub-configuration contained in a CSI-ReportConfig if each of the sub-configuration(s) contains a list of one or more NZP CSI-RS resources, or all the resources of a NZP CSI-RS Resource Set for channel measurement correspond to each of the sub-configuration(s) contained in a CSI-ReportConfig if each of the sub-configurations does not contain a list of NZP CSI-RS resources, as described in Clause 5.2.1.4.2.

### 5.2.1.4.2 Report Quantity Configurations

A UE may be configured with a CSI-ReportConfig with the higher layer parameter reportQuantity set to either ‘none’, ‘cri-RI-PMI-CQI’, ‘cri-RI-i1’, ‘cri-RI-i1-CQI’, ‘cri-RI-CQI’, ‘cri-RSRP’, ‘cri-SINR’, ‘ssb-Index-RSRP’, ‘ssb-Index-SINR’, ‘cri-RI-LI-PMI-CQI’, ‘cri-RSRP-Index’, ‘ssb-Index-RSRP-Index’, ‘cri-SINR-Index’, ‘ssb-Index-SINR-Index’ or ‘tdcp’.

. . .

### 5.2.1.4.3 L1-RSRP Reporting

For L1-RSRP computation
the UE may be configured with CSI-RS resources, SS/PBCH Block resources or both CSI-RS and SS/PBCH block resources, when resource-wise quasi co-located with ‘type C’ and ‘typeD’ when applicable.
the UE may be configured with CSI-RS resource setting up to 16 CSI-RS resource sets having up to 64 resources within each set. The total number of different CSI-RS resources over all resource sets is no more than 128.

For L1-RSRP reporting, if the higher layer parameter nrofReportedRS in CSI-ReportConfig is configured to be one, or if the higher layer parameters [noOfReportedCells] and [noOfReportedRSPerCell] are both configured to be one, the reported L1-RSRP value is defined by a 7-bit value in the range [−140, −44] dBm with 1 dB step size, if the higher layer parameter nrofReportedRS is configured to be larger than one, or if the higher layer parameter groupBasedBeamReporting is configured as ‘enabled’, or if the higher layer parameter groupBasedBeamReporting-r17 is configured, or if any of the higher layer parameters [noOfReportedCells] and [noOfReportedRSPerCell] is configured to be larger than one, the UE shall use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The mapping between the reported L1-RSRP value and the measured quantity is described in [11, TS 38.133].

When the higher layer parameter groupBasedBeamReporting-r17 in CSI-ReportConfig is configured, the UE shall indicate the CSI Resource Set associated with the largest measured value of L1-RSRP, and for each group, CRI or SSBRI of the indicated CSI Resource Set is present first.

When the UE is configured with SSB-MTC-AddtionalPCI, a CSI-SSB-ResourceSet configured for L1-RSRP reporting includes one set of SSB indices and one set of PCI indices, where each SSB index is associated with a PCI index.

When the UE is configured with a CSI-ReportConfig with the higher layer parameter reportQuantity set to ‘cri-RSRP-Index’ or ‘ssb-Index-RSRP-Index’ an index of UE capability value set, indicating the maximum supported number of SRS antenna ports, is reported along with the pair of SSBRI/CRI and L1-RSRP.

. . .

### 5.2.1.5 Triggering/Activation of CSI Reports and CSI-RS

5.2.1.5.1 Aperiodic CSI Reporting/Aperiodic CSI-RS when the Triggering PDCCH and the CSI-RS have the Same Numerology

For CSI-RS resource sets associated with Resource Settings configured with the higher layer parameter resourceType set to ‘aperiodic’, ‘periodic’, or ‘semi-persistent’, trigger states for Reporting Setting(s) (configured with the higher layer parameter reportConfigType set to ‘aperiodic’) and/or Resource Setting for channel and/or interference measurement on one or more component carriers are configured using the higher layer parameter CSI-AperiodicTriggerStateList. For a reporting setting for which the CSI-ReportConfig contains a list of sub-configurations provided by the higher layer parameter [csi-ReportSubConfigList], one or more trigger states can be configured with each indicating one or more of the sub-configurations. For aperiodic CSI report triggering, a single set of CSI triggering states are higher layer configured, wherein the CSI triggering states can be associated with any candidate DL BWP. A UE is not expected to receive more than one DCI with non-zero CSI request field per slot per cell. A UE is not expected to receive DCI with non-zero CSI request field within a cell group in a slot overlapping with any slot receiving DCI with non-zero CSI request field in the same cell group. A UE is not expected to be configured with different TCI-StateId's for the same aperiodic CSI-RS resource ID configured in multiple aperiodic CSI-RS resource sets with the same triggering offset in the same aperiodic trigger state. A UE is not expected to receive more than one aperiodic CSI report request for transmission in a given slot per cell. A UE is not expected to receive an aperiodic CSI report request for transmission in a slot overlapping with any slot having an aperiodic CSI report transmission in the same cell group. If a UE does not indicate its capability of CSItriggerStateContainingNonactiveBWP the UE is not expected to be triggered with a CSI report for a non-active DL BWP. Otherwise, when a UE is triggered with a CSI report for a DL BWP that is non-active when expecting to receive the most recent occasion, no later than the CSI reference resource, of the associated NZP CSI-RS, the UE is not expected to report the CSI for the non-active DL BWP and the CSI report associated with that BWP is omitted. When a UE is triggered with aperiodic NZP CSI-RS in a DL BWP that is non-active when expecting to receive the NZP CSI-RS, the UE is not expected to measure the aperiodic CSI-RS. In the carrier of the serving cell expecting to receive that associated NZP CSI-RS, if the active DL BWP when receiving the NZP CSI-RS is different from the active DL BWP when receiving the triggering DCI,
the last symbol of the PDCCH span of the DCI carrying the BWP switching shall be no later than the last symbol of the PDCCH span of the DCI carrying the CSI trigger, irrespective of whether they are in the same carrier of a serving cell or not and irrespective of whether they are in the same SCS or not;
the UE is not expected to have any other BWP switching in that carrier after the last symbol of the PDCCH span covering the DCI carrying the CSI trigger and before the first symbol of the triggered NZP CSI-RS or CSI-IM.

A trigger state is initiated using the CSI request field in DCI.
When all the bits of CSI request field in DCI are set to zero, no CSI is requested.
When the number of configured CSI triggering states in CSI-AperiodicTriggerStateList is greater than 2^{N}^{_{TS}}−1, where N_{TS} is the number of bits in the DCI CSI request field, the UE receives a subselection indication, as described in clause 6.1.3.13 of [10, TS 38.321], used to map up to 2^{N}^{_{TS}}−1 trigger states to the codepoints of the CSI request field in DCI. N_{TS} is configured by the higher layer parameter reportTriggerSize where N_{TS} ∈{0,1,2,3,4,5,6}. When the UE would transmit a PUCCH with HARQ-ACK information in slot n corresponding to the PDSCH carrying the subselection indication, the corresponding action in [10, TS 38.321] and UE assumption on the mapping of the selected CSI trigger state(s) to the codepoint(s) of DCI CSI request field shall be applied starting from the first slot that is after slot

$$n + 3 {N}_{slot}^{s u b f r ame , μ} + \frac{{2}^{μ}}{{2}^{{μ}_{{K}_{mac}}}} \cdot {k}_{mac}$$

where μ is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided.
When the number of CSI triggering states in CSI-AperiodicTriggerStateList is less than or equal to 2^{N}^{_{TS}}−1, the CSI request field in DCI directly indicates the triggering state.
For each aperiodic CSI-RS resource in a CSI-RS resource set associated with each CSI triggering state, the UE is indicated the quasi co-location configuration of quasi co-location RS source(s) and quasi co-location type(s), as described in clause 5.1.5, through higher layer signaling of qcl-info which contains a list of references to TCI-State's for the aperiodic CSI-RS resources associated with the CSI triggering state. If a State referred to in the list is configured with a reference to an RS configured with qcl-Type set to ‘typeD’, that RS may be an SS/PBCH block located in the same or different CC/DL BWP or a CSI-RS resource configured as periodic or semi-persistent located in the same or different CC/DL BWP.
   If the scheduling offset between the last symbol of the PDCCH carrying the triggering DCI and the first symbol of the aperiodic CSI-RS resources in a NZP-CSI-RS-ResourceSet configured without higher layer parameter trs-Info is smaller than the UE reported threshold beamSwitchTiming, as defined in [13, TS 38.306], when the reported value is one of the values of {14, 28, 48}·2^{max(0,μ}^{_{CSIRS}}⁻³⁾ and enableBeamSwitch Timing is not provided, or is smaller than 48·2^{max(0,μ}^{_{CSIRS}}⁻³⁾ when the UE provides beamSwitchTiming-r16, enableBeamSwitchTiming is provided and the NZP-CSI-RS-ResourceSet is configured with the higher layer parameter repetition set to ‘off’ or configured without the higher layer parameter repetition, or is smaller than the UE reported threshold beamSwitchTiming-r16, when enableBeamSwitchTiming is provided and the NZP-CSI-RS-ResourceSet is configured with the higher layer parameter repetition set to ‘on’.
A non-zero codepoint of the CSI request field in the DCI is mapped to a CSI triggering state according to the order of the associated positions of the up to 2^{N}^{_{TS}}−1 trigger states in CSI-AperiodicTriggerStateList with codepoint ‘1’ mapped to the triggering state in the first position.

For a UE configured with the higher layer parameter CSI-AperiodicTriggerStateList, if a Resource Setting linked to a CSI-ReportConfig has multiple aperiodic resource sets, only one of the aperiodic CSI-RS resource sets from the Resource Setting is associated with the trigger state, and the UE is higher layer configured per trigger state per Resource Setting to select the one CSI-IM/NZP CSI-RS resource set from the Resource Setting.

If the UE is configured with a single carrier for uplink, the UE is not expected to transmit more than one aperiodic CSI report triggered by different DCIs on overlapping OFDM symbols.

When a UE is configured with dl-OrJointTCI-StateList and is having two indicated TCI states, a higher layer configuration can be provided to an aperiodic CSI-RS resource set or a CSI-RS resource in an aperiodic CSI-RS resource set to inform that the UE shall apply the first or the second indicated TCI-State to the aperiodic CSI-RS resource set or to the CSI-RS resource in the aperiodic CSI-RS resource set, if the aperiodic CSI-RS resource set for CSI or BM is configured with followUnifiedTCI-State and if the offset between the last symbol of the PDCCH carrying the triggering DCI and the first symbol of the aperiodic CSI-RS resources in the aperiodic CSI-RS resource set is equal to or larger than a threshold.
If the UE is configured by higher layer parameter PDCCH-Config that contains two different values of CORESETPoolIndex in different ControlResourceSets, the first and the second indicated TCI-States correspond to the indicated TCI-States specific to coresetPoolIndex value 0 and value 1, respectively.

When a UE is configured with dl-OrJointTCI-StateList and is having two indicated TCI states and if the offset between the last symbol of the PDCCH carrying the triggering DCI and the first symbol of the aperiodic CSI-RS resources in the aperiodic CSI-RS resource set is smaller than a threshold:
If there is no DL signal in the same symbols as the aperiodic CSI-RS
   if the UE is in frequency range 1, or the UE reports its capability of [two default beams for S-DCI based MTRP] in frequency range 2, the UE shall apply the first or the second indicated joint/DL TCI state to the aperiodic CSI-RS according to the higher layer configuration(s) provided to the aperiodic CSI-RS resource or to the aperiodic CSI-RS resource set.
   Otherwise, the UE shall apply the first indicated joint/DL TCI state to the aperiodic CSI-RS.

When a UE is configured with dl-OrJointTCI-StateList, is configured by higher layer parameter PDCCH-Config that contains two different values of coresetPoolIndex in different ControlResourceSets, is having two indicated TCI states and if the offset between the last symbol of the PDCCH carrying the triggering DCI and the first symbol of the aperiodic CSI-RS resources in the aperiodic CSI-RS resource set is smaller than a threshold:
If there is no DL signal in the same symbols as the aperiodic CSI-RS
   if the UE is in frequency range 1, or the UE reports its capability of [default beam per coresetPoolIndex for M-DCI based MTRP] in frequency range 2, the UE shall apply the first or the second indicated joint/DL TCI state to the aperiodic CSI-RS according to the higher layer configuration(s) provided to the aperiodic CSI-RS resource or aperiodic CSI-RS resource set.
Otherwise, the UE shall apply the indicated joint/DL TCI state specific to coresetPoolIndex value 0 to the aperiodic CSI-RS resource set.

. . .

. . .
In [3]R1-2204369, the following is provided.

### Deployment Scenario of CJT

In Rel-18 MIMO WID for CJT, ideal backhaul and synchronization as well as the same number of antenna ports across up to 4 TRPs are assumed. For multiple TRPs for CJT, generally there are two deployment scenarios for discussion: intra-site M-TRP and inter-site M-TRP, as shown in FIG. 3-1.

For intra-site M-TRP CJT, the multiple TRPs are co-located and have the same transmission power. One example is to consider simultaneous transmission from multiple panels from the same gNB. For inter-site M-TRP CJT, the multiple TRPs are non-co-located. In that case, a UE can be scheduled with CJT transmission only when the measured RSRP from multiple TRPs are within a certain threshold. And the synchronization among multiple TRPs can be ensured with fiber backhaul.

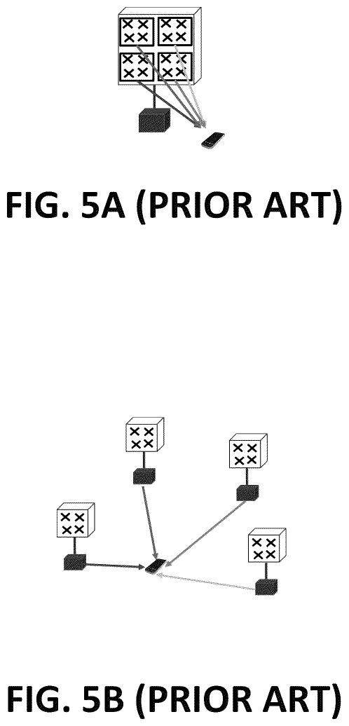

FIG. 5A is a reproduction of Fig. 3-1: Two deployment scenarios for M-TRP CJT, (a) Intra-site M-TRP CJT, from R1-2204369.

FIG. 5B is a reproduction of Fig. 3-1: Two deployment scenarios for M-TRP CJT, (b) Inter-site M-TRP CJT, from R1-2204369.

In Rel-18, we should study both intra-site M-TRP and inter-site M-TRP scenarios and identify the high priority scenario for NW deployment. Since it is easier to deploy intra-site M-TRP CJT in real NW, it can have higher priority for discussion in Rel-18.

### Proposal 3-1

Study both intra-site M-TRP and inter-site M-TRP scenarios for CJT.
Intra-site M-TRP CJT has higher priority than inter-site M-TRP CJT.
   In [4]3GPP TS 38.211 i00, relevant paragraphs are quoted below.

### 4 Frame Structure and Physical Resources

### 4.1 General

Throughout this specification, unless otherwise noted, the size of various fields in the time domain is expressed in time units T_{c}=1/(Δfₘₐₓ·N_{f}) where Δfₘₐₓ=480·10³ Hz and N_{f}=4096. The constant κ=Tₛ/T_{c}=64 where Tₛ=1/(Δf_{ref}·N_{f,ref}), Δf_{ref}=15·10³ Hz and N_{f,ref}=2048.

. . .

### 4.4 Physical Resources

### 4.4.1 Antenna Ports

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.
In [5]3GPP TS 38.212 i00, relevant paragraphs are quoted below.

### 7.3.1.1.2 Format 0_1

DCI format 0_1 is used for the scheduling of one or multiple PUSCH in one cell, or indicating CG downlink feedback information (CG-DFI) to a UE.

The following information is transmitted by means of the DCI format 0_1 with CRC scrambled by C-RNTI or CS-RNTI or SP-CSI-RNTI or MCS-C-RNTI:
Identifier for DCI formats—1 bit
   The value of this bit field is always set to 0, indicating an UL DCI format
Carrier indicator—0 or 3 bits, as defined in Clause 10.1 of [5, TS38.213]. This field is reserved when this format is carried by PDCCH on the primary cell and the UE is configured for scheduling on the primary cell from an SCell, with the same number of bits as that in this format carried by PDCCH on the SCell for scheduling on the primary cell.
Bandwidth part indicator—0, 1 or 2 bits as determined by the number of UL BWPs n_{BWP,RRC} configured by higher layers, excluding the initial UL bandwidth part. The bitwidth for this field is determined as ┌log₂(n_{BWP})┐ bits, where
   n_{BWP}=n_{BWP,RRC}+1 if n_{BWP,RRC}≤3, in which case the bandwidth part indicator is equivalent to the ascending order of the higher layer parameter BWP-Id;
   otherwise n_{BWP}=n_{BWP,RRC}, in which case the bandwidth part indicator is defined in Table 7.3.1.1.2-1;
Frequency domain resource assignment—number of bits determined by the following, where N_{RB}^{UL,BWP} is the size of the active UL bandwidth part:
   If higher layer parameter useInterlacePUCCH-PUSCH in BWP-UplinkDedicated is not configured
      For resource allocation type 0, the . . .
      For non-PUSCH hopping with resource allocation type 1:
         ┌log₂(N_{RB}^{UL,BWP}(N_{RB}^{UL,BWP}+1)/2)┐ bits provide the frequency domain resource allocation according to Clause 6.1.2.2.2 of [6, TS 38.214]
Time domain resource assignment—0, 1, 2, 3, 4, 5, or 6 bits
   If the higher layer parameter pusch-TimeDomainAllocationListDCI-0-1 is not configured and if the higher layer parameter pusch-TimeDomainAllocationListForMultiPUSCH is not configured and if the higher layer parameter pusch-TimeDomainAllocationList is configured, 0, 1, 2, 3, or 4 bits as defined in Clause 6.1.2.1 of [6, TS38.214]. The bitwidth for this field is determined as ┌log₂(I)┐ bits, where I is the number of entries in the higher layer parameter pusch-TimeDomainAllocationList;
. . .
   otherwise the bitwidth for this field is determined as ┌log₂(I)┐ bits, where I is the number of entries in the default table.
      For transport block 1:
Modulation and coding scheme—5 bits as defined in Clause 6.1.4.1 of [6, TS 38.214]
New data indicator—1 bit if the number of scheduled PUSCH indicated by the Time domain resource assignment field is 1; otherwise 2, 3, 4, 5, 6, 7 or 8 bits determined based on the maximum number of schedulable PUSCH among all entries in the higher layer parameter pusch-TimeDomainAllocationListForMultiPUSCH, where each bit corresponds to one scheduled PUSCH as defined in clause 6.1.4 in [6, TS 38.214].
Redundancy version—number of bits determined by the following:
   2 bits as defined in Table 7.3.1.1.1-2 if the number of scheduled PUSCH indicated by the Time domain resource assignment field is 1;
   otherwise 2, 3, 4, 5, 6, 7 or 8 bits determined by the maximum number of schedulable PUSCHs among all entries in the higher layer parameter pusch-TimeDomainAllocationListForMultiPUSCH, where each bit corresponds to one scheduled PUSCH as defined in clause 6.1.4 in [6, TS 38.214] and redundancy version is determined according to Table 7.3.1.1.2-34.
. . .
HARQ process number—5 bits if higher layer parameter harq-ProcessNumberSizeDCI-0-1 is configured; otherwise 4 bits
. . .
CSI request—0, 1, 2, 3, 4, 5, or 6 bits determined by higher layer parameter reportTriggerSize.
. . .

. . .

### 7.3.1.2.2 Format 1_1

DCI format 1_1 is used for the scheduling of one or multiple PDSCH in one cell.

The following information is transmitted by means of the DCI format 1_1 with CRC scrambled by C-RNTI or CS-RNTI or MCS-C-RNTI:
Identifier for DCI formats—1 bits
   The value of this bit field is always set to 1, indicating a DL DCI format
Carrier indicator—0 or 3 bits as defined in Clause 10.1 of [5, TS 38.213]. This field is reserved when this format is carried by PDCCH on the primary cell and the UE is configured for scheduling on the primary cell from an SCell, with the same number of bits as that in this format carried by PDCCH on the SCell for scheduling on the primary cell.
Bandwidth part indicator—0, 1 or 2 bits as determined by the number of DL BWPs n_{BWP,RRC} configured by higher layers, excluding the initial DL bandwidth part. The bitwidth for this field is determined as ┌log₂(n_{BWP})┐ bits, where
   n_{BWP}=n_{BWP,RRC}+1 if n_{BWP,RRC}≤3, in which case the bandwidth part indicator is equivalent to the ascending order of the higher layer parameter BWP-Id;
   otherwise n_{BWP}=n_{BWP,RRC}, in which case the bandwidth part indicator is defined in Table 7.3.1.1.2-1;
. . .
Transmission configuration indication—0 bit if higher layer parameter tci-PresentInDCI is not enabled; otherwise 3 bits as defined in Clause 5.1.5 of [6, TS38.214].
   . . .

. . .
In [6]3GPP TS 38.331 h60, relevant information for element (IE) and parameters are quoted below.

| | |
|---|---|
| mTRP-CSI-EnhancementPerBC-r17 | SEQUENCE { |
| maxNumNZP-CSI-RS-r17 | INTEGER (2..8), |
| cSI-Report-mode-r17 | ENUMERATED {mode1, mode2, both}, |
| supportedComboAcrossCCs-r17 | SEQUENCE (SIZE (1..16)) OF CSI-MultiTRP- |

```
SupportedCombinations-r17,
    codebookMode-NCJT-r17 ENUMERATED{mode1,mode1And2}
  }
- CSI-AperiodicTriggerStateList
```

The CSI-AperiodicTriggerStateList IE is used to configure the UE with a list of aperiodic trigger states. Each codepoint of the DCI field “CSI request” is associated with one trigger state (see TS 38.321 [3], clause 6.1.3.13). Upon reception of the value associated with a trigger state, the UE will perform measurement of CSI-RS, CSI-IM and/or SSB (reference signals) and aperiodic reporting on L1 according to all entries in the associatedReportConfigInfoList for that trigger state.

CSI-AperiodicTriggerStateList information element

| | |
|---|---|
| CSI-AperiodicTriggerStateList ::= | SEQUENCE (SIZE (1..maxNrOfCSI-AperiodicTriggers)) OF CSI- |

AperiodicTriggerState

| | |
|---|---|
| CSI-AperiodicTriggerState ::= | SEQUENCE { |
| associatedReportConfigInfoList | SEQUENCE (SIZE(1..maxNrofReportConfigPerAperiodicTrigger)) OF |

```
CSI-AssociatedReportConfigInfo,
  ...,
  [[
```

| | |
|---|---|
| ap-CSI-MultiplexingMode-r17 | ENUMERATED {enabled} |

OPTIONAL -- Need R
]]
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) |

OF TCI-StateId
OPTIONAL -- Cond Aperiodic
},

| | |
|---|---|
| csi-SSB-ResourceSet | INTEGER (1..maxNrofCSI-SSB-ResourceSetsPerConfig) |

```
  },
    ]]
}
```

CSI-AssociatedReportConfigInfo field descriptions

ap-CSI-MultiplexingMode
Indicates if the behavior of transmitting aperiodic CSI on the first PUSCH repetitions corresponding to two SRS
resource sets configured in srs-ResourceSetToAddModList or srs-ResourceSetToAddModListDCI-0-2 with usage
‘codebook or ‘noncodebook is enabled or not.
csi-SSB-ResourceSet, csi-SSB-ResourceSet2
CSI-SSB-ResourceSet for channel measurements. Entry number in csi-SSB-ResourceSetList in the CSI-
ResourceConfig indicated by resourcesForChannelMeasurement in the CSI-ReportConfig indicated by reportConfigId
above (value 1 corresponds to the first entry, value 2 to the second entry, and so on).
qcl-info, qcl-info2
List of references to TCI-States for providing the QCL source and QCL type for each NZP-CSI-RS-Resource listed in
nzp-CSI-RS-Resources of the NZP-CSI-RS-ResourceSet indicated by resourceSet within nzp-CSI-RS. Each TCI-
Stateld refers to the TCI-State which has this value for tci-Stateld and is defined in tci-States ToAddModList or in di-
OrJointTCI-StateList in the PDSCH-Config included in the BWP-Downlink corresponding to the serving cell and to the
DL BWP to which the resourcesForChannelMeasurement (in the CSI-ReportConfig indicated by reportConfigId above)
belong to. First entry in qcl-info corresponds to first entry in nzp-CSI-RS-Resources of that NZP-CSI-RS-ResourceSet,
second entry in qcl-info corresponds to second entry in nzp-CSI-RS-Resources, and so on (see TS 38.214 [19], clause
5.2.1.5.1). When this field is absent for aperiodic CSI RS, the UE shall use QCL information included in the “indicated”
DL only/Joint TCI state as specified in TS 38.214
reportConfigId
The reportConfigId of one of the CSI-ReportConfigToAddMod configured in CSI-MeasConfig
resourceSet
NZP-CSI-RS-ResourceSet for channel measurements. Entry number in nzp-CSI-RS-ResourceSetList in the CSI-
ResourceConfig indicated by resourcesForChannelMeasurement in the CSI-ReportConfig indicated by reportConfigId
above (value 1 corresponds to the first entry, value 2 to the second entry, and so on).

### CSI-MeasConfig

The IE CSI-MeasConfig is used to configure CSI-RS (reference signals) belonging to the serving cell in which CSI-MeasConfig is included, channel state information reports to be transmitted on PUCCH on the serving cell in which CSI-MeasConfig is included and channel state information reports on PUSCH triggered by DCI received on the serving cell in which CSI-MeasConfig is included. See also TS 38.214 [19], clause 5.2.

CSI-MeasConfig information element

| | |
|---|---|
| CSI-MeasConfig ::= | SEQUENCE { |
| nzp-CSI-RS-ResourceToAddModList | SEQUENCE (SIZE (1..maxNrofNZP-CSI-RS-Resources)) OF NZP-CSI- |

RS-Resource OPTIONAL, -- Need N

| | |
|---|---|
| nzp-CSI-RS-ResourceToReleaseList | SEQUENCE (SIZE (1..maxNrofNZP-CSI-RS-Resources)) OF NZP-CSI- |

RS-ResourceId OPTIONAL, -- Need N

| | |
|---|---|
| nzp-CSI-RS-ResourceSetToAddModList | SEQUENCE (SIZE (1..maxNrofNZP-CSI-RS-ResourceSets)) OF NZP- |

CSI-RS-ResourceSet
OPTIONAL, -- Need N

| | |
|---|---|
| nzp-CSI-RS-ResourceSetToReleaseList | SEQUENCE (SIZE (1..maxNrofNZP-CSI-RS-ResourceSets)) OF NZP- |

CSI-RS-ResourceSetId
OPTIONAL, -- Need N

| | |
|---|---|
| csi-ResourceConfigToAddModList | SEQUENCE (SIZE (1..maxNrofCSI-ResourceConfigurations)) OF |

CSI-ResourceConfig
OPTIONAL, -- Need N

| | |
|---|---|
| csi-ResourceConfigToReleaseList | SEQUENCE (SIZE (1..maxNrofCSI-ResourceConfigurations)) OF |

CSI-ResourceConfigId
OPTIONAL, -- Need N

| | |
|---|---|
| csi-ReportConfigToAddModList | SEQUENCE (SIZE (1..maxNrofCSI-ReportConfigurations)) OF CSI- |

ReportConfig OPTIONAL, -- Need N

| | |
|---|---|
| csi-ReportConfigToReleaseList | SEQUENCE (SIZE (1..maxNrofCSI-ReportConfigurations)) OF CSI- |

ReportConfigId
OPTIONAL, -- Need N

| | |
|---|---|
| reportTriggerSize | INTEGER (0..6) |

OPTIONAL, -- Need M

| | |
|---|---|
| aperiodicTriggerStateList | SetupRelease { CSI-AperiodicTriggerStateList } |

OPTIONAL, -- Need M
]]
}

CSI-MeasConfig field descriptions

aperiodic TriggerStateList
Contains trigger states for dynamically selecting one or more aperiodic and semi-persistent reporting configurations
and/or triggering one or more aperiodic CSI-RS resource sets for channel and/or interference measurement (see TS
38.214 [19], clause 5.2.1).
csi-ReportConfigToAddModList
Configured CSI report settings as specified in TS 38.214 [19] clause 5.2.1.1.
csi-ResourceConfigToAddModList
Configured CSI resource settings as specified in TS 38.214 [19] clause 5.2.1.2.
csi-SSB-ResourceSetToAddModList
Pool of CSI-SSB-ResourceSet which can be referred to from CSI-ResourceConfig.
nzp-CSI-RS-ResourceSetToAddModList
Pool of NZP-CSI-RS-ResourceSet which can be referred to from CSI-ResourceConfig or from MAC CEs.
nzp-CSI-RS-ResourceToAddModList
Pool of NZP-CSI-RS-Resource which can be referred to from NZP-CSI-RS-ResourceSet.
reportTriggerSize, reportTriggerSizeDCI-0-2
Size of CSI request field in DCI (bits) (see TS 38.214 [19], clause 5.2.1.5.1). The field reportTriggerSize applies to DCI
format 0_1 and the field reportTriggerSizeDCI-0-2 applies to DCI format 0_2 (see TS 38.214 [19], clause 5.2.1.5.1).
Configured RS for fast SCell activation as specified in TS 38.214 [19] clause 5.2.1.5.3.

### CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214 [19], clause 5.2.1.

CSI-ReportConfig information element

| | |
|---|---|
| CSI-ReportConfig ::= | SEQUENCE { |
| reportConfigId | CSI-ReportConfigId, |
| carrier | ServCellIndex OPTIONAL, -- Need S |
| resourcesForChannelMeasurement | CSI-ResourceConfigId, |
| nzp-CSI-RS-ResourcesForInterference | CSI-ResourceConfigId |
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, |

sl320},

| | |
|---|---|
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

```
  },
      }
  }
OPTIONAL, -- Need R
    }
  },
  }
OPTIONAL, -- Need R
```

| | |
|---|---|
| aperiodic-v1610 | SEQUENCE { |
| reportSlotOffsetListDCI-0-2-r16 | SEQUENCE (SIZE (1.. maxNrofUL-Allocations-r16)) OF |

INTEGER(0..32) OPTIONAL, -- Need R

| | |
|---|---|
| reportSlotOffsetListDCI-0-1-r16 | SEQUENCE (SIZE (1.. maxNrofUL-Allocations-r16)) OF |

INTEGER(0..32) OPTIONAL -- Need R
}
OPTIONAL, -- Need R

| | |
|---|---|
| reportQuantity-r16 | CHOICE { |
| cri-SINR-r16 | NULL, |
| ssb-Index-SINR-r16 | NULL |

}
OPTIONAL, -- Need R

| | |
|---|---|
| reportQuantity-r17 | CHOICE { |
| cri-RSRP-Index-r17 | NULL, |
| ssb-Index-RSRP-Index-r17 | NULL, |
| cri-SINR-Index-r17 | NULL, |
| ssb-Index-SINR-Index-r17 | NULL |

```
  }
OPTIONAL, -- Need R
  ]],
  [[
    }
```

| | |
|---|---|
| aperiodic-v1720 | SEQUENCE { |
| reportSlotOffsetList-r17 | SEQUENCE (SIZE (1.. maxNrofUL-Allocations-r16)) OF |

INTEGER(0..128) OPTIONAL, -- Need R

| | |
|---|---|
| reportSlotOffsetListDCI-0-2-r17 | SEQUENCE (SIZE (1.. maxNrofUL-Allocations-r16)) OF |

INTEGER(0..128) OPTIONAL, -- Need R

| | |
|---|---|
| reportSlotOffsetListDCI-0-1-r17 | SEQUENCE (SIZE (1.. maxNrofUL-Allocations-r16)) OF |

```
INTEGER(0..128) OPTIONAL -- Need R
  }
OPTIONAL -- Need R
  ]],
  [[
    ]]
}
CSI-ReportPeriodicityAndOffset ::= CHOICE {
```

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

CSI-ReportConfig field descriptions

carrier
Indicates in which serving cell the CSI-ResourceConfig indicated below are to be found. If the field is absent, the
resources are on the same serving cell as this report configuration.
reportConfigType
Time domain behavior of reporting configuration.
reportFreqConfiguration
Reporting configuration in the frequency domain. (see TS 38.214 [19], clause 5.2.1.4).
reportQuantity
The CSI related quantities to report. see TS 38.214 [19], clause 5.2.1. If the field reportQuantity-r16 or reportQuantity-
r17 is present, UE shall ignore reportQuantity (without suffix). Network does not configure reportQuantity-r17 together
with reportQuantity-r16.
reportSlotConfig
Periodicity and slot offset (see TS 38.214 [19], clause 5.2.1.4). If the field reportSlotConfig-v1530 is present, the UE
shall ignore the value provided in reportSlotConfig (without suffix).
resourcesForChannelMeasurement
Resources for channel measurement. csi-ResourceConfigId of a CSI-ResourceConfig included in the configuration of
the serving cell indicated with the field “carrier” above. The CSI-ResourceConfig indicated here contains only NZP-CSI-
RS resources and/or SSB resources. This CSI-ReportConfig is associated with the DL BWP indicated by bwp-Id in that
CSI-ResourceConfig.

### CSI-ResourceConfig

The IE CSI-ResourceConfig defines a group of one or more NZP-CSI-RS-ResourceSet, CSI-IM-ResourceSet and/or CSI-SSB-ResourceSet.

CSI-ResourceConfig information element

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP-CSI-RS-ResourceSetsPerConfig)) |

OF NZP-CSI-RS-ResourceSetId
OPTIONAL, -- Need R

| | |
|---|---|
| csi-SSB-ResourceSetList | SEQUENCE (SIZE (1..maxNrofCSI-SSB-ResourceSetsPerConfig)) OF |

CSI-SSB-ResourceSetId OPTIONAL -- Need R
},

| | |
|---|---|
| csi-IM-ResourceSetList | SEQUENCE (SIZE (1..maxNrofCSI-IM-ResourceSetsPerConfig)) OF CSI- |

IM-ResourceSetId
},

| | |
|---|---|
| bwp-Id | BWP-Id, |
| resourceType | ENUMERATED { aperiodic, semiPersistent, periodic }, |

```
  ...,
  [[
```

| | |
|---|---|
| csi-SSB-ResourceSetListExt-r17 | CSI-SSB-ResourceSetId |

OPTIONAL -- Need R
]]
}

CSI-ResourceConfig field descriptions
bwp-Id
The DL BWP which the CSI-RS associated with this CSI-ResourceConfig are located in (see TS 38.214 [19], clause
5.2.1.2.
csi-ResourceConfigId
Used in CSI-ReportConfig to refer to an instance of CSI-ResourceConfig.
csi-SSB-ResourceSetList, csi-SSB-ResourceSetListExt
List of references to SSB resources used for CSI measurement and reporting in a CSI-RS resource set (see TS 38.214
[19], clause 5.2.1.2). The csi-SSB-ResourceSetListExt provides additional references and can only be configured if csi-
SSB-ResourceSetList is configured and groupBasedBeamReporting-v1710 is configured in the CSI-ReportConfig that
indicates this CSI-ResourceConfig as resourcesForChannelMeasurement. If groupBasedBeamReporting-v1710 is
configured in the IE CSI-ReportConfig that indicates this CSI-ResourceConfig as resourceForChannelMeasurement, the
network configures 2 resource sets, which may be two NZP CSI-RS resource sets, two CSI SSB resource sets or one
NZP CSI-RS resource set and one CSI-SSB resource set (see TS 38.214 [19], clause 5.2.1.2 and 5.2.1.4.2). In this
case, in TS 38.212 [17] Table 6.3.1.1.2-8B:
- if the list has one CSI-SSB resource set, this resource set is indicated by a resource set indicator set to 1, while the
resource set indicator of the NZP CSI-RS resource set is 0;
- if the list has two CSI-SSB resource sets, the first resource set is indicated by a resource set indicator set to 0 and the
second resource set by a resource set indicator set to 1.
nzp-CSI-RS-ResourceSetList
List of references to NZP CSI-RS resources used for beam measurement and reporting in a CSI-RS resource set.
If resourceType is set to ‘aperiodic’, the network configures up to maxNrofNZP-CSI-RS-ResourceSetsPerConfig
resource sets. If resource Type is is set to ‘periodic’ or ‘semiPersistent’ and groupBasedBeamReporting-v1710 is not
configured in IE CSI-ReportConfig, the network configures 1 resource set. If resource Type is set to ‘periodic’ or
‘semiPersistent’ and groupBasedBeamReporting-v1710 is configured, the network configures 2 resource sets, which
may be two NZP CSI-RS resource sets, two CSI SSB resource sets or one NZP CSI-RS resource set and one CSI-SSB
resource set (see TS 38.214 [19], clause 5.2.1.2 and 5.2.1.4.2). In this case, in TS 38.212 [17] Table 6.3.1.1.2-8B, the
following applies:
- if the list has one NZP CSI-RS resource set, this resource set is indicated by a resource set indicator set to 0;
- if the list has two NZP CSI-RS resource sets, the first resource set is indicated by a resource set indicator set to 0 and
the second resource set by a resource set indicator set to 1.
resource Type
Time domain behavior of resource configuration (see TS 38.214 [19], clause 5.2.1.2). It does not apply to resources
provided in the csi-SSB-ResourceSetList.

### ZP-CSI-RS-Resource

The IE ZP-CSI-RS-Resource is used to configure a Zero-Power (ZP) CSI-RS resource (see TS 38.214 [19], clause 5.1.4.2). Reconfiguration of a ZP-CSI-RS-Resource between periodic or semi-persistent and aperiodic is not supported.

ZP-CSI-RS-Resource information element

| | |
|---|---|
| ZP-CSI-RS-Resource ::= | SEQUENCE { |
| zp-CSI-RS-ResourceId | ZP-CSI-RS-ResourceId, |
| resourceMapping | CSI-RS-ResourceMapping, |
| periodicityAndOffset | CSI-ResourcePeriodicityAndOffset OPTIONAL, -- |

Cond PeriodicOrSemiPersistent
...
}

| | |
|---|---|
| ZP-CSI-RS-ResourceId ::= | INTEGER (0..maxNrofZP-CSI-RS-Resources-1) |

ZP-CSI-RS-Resource field descriptions

periodicityAndOffset
Periodicity and slot offset for periodic/semi-persistent ZP-CSI-RS (see TS 38.214 [19], clause 5.1.4.2). Network always
configures the UE with a value for this field for periodic and semi-persistent ZP-CSI-RS resource (as indicated in
PDSCH-Config).
resourceMapping
OFDM symbol and subcarrier occupancy of the ZP-CSI-RS resource within a slot.
zp-CSI-RS-Resourceld
ZP CSI-RS resource configuration ID (see TS 38.214 [19], clause 5.1.4.2).

### ZP-CSI-RS-ResourceSet

The IE ZP-CSI-RS-ResourceSet refers to a set of ZP-CSI-RS-Resources using their ZP-CSI-RS-ResourceIds.

ZP-CSI-RS-ResourceSet information element

| | |
|---|---|
| ZP-CSI-RS-ResourceSet ::= | SEQUENCE { |
| zp-CSI-RS-ResourceSetId | ZP-CSI-RS-ResourceSetId, |
| zp-CSI-RS-ResourceIdList | SEQUENCE (SIZE(1..maxNrofZP-CSI-RS-ResourcesPerSet)) OF ZP- |

CSI-RS-ResourceId,
...
}

ZP-CSI-RS-ResourceSet field descriptions

zp-CSI-RS-ResourceldList
The list of ZP-CSI-RS-Resourceld identifying the ZP-CSI-RS-Resource elements belonging to this set.

### TCI-State

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PathlossReferenceRS-Id-r17 |

OPTIONAL, -- Cond JointTCI1

| | |
|---|---|
| ul-powerControl-r17 | Uplink-powerControlId-r17 |

OPTIONAL -- Cond JointTCI
]]
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

QCL-Info field descriptions

bwp-Id
The DL BWP which the RS is located in. If the field is absent, the RS is located in the DL BWP in which the TCI-State is
applied by the UE.
cell
The UE's serving cell in which the referenceSignal is configured. If the field is absent, the referenceSignal is configured
in the serving cell in which the TCI-State is applied by the UE. The RS can be located on a serving cell other than the
serving cell for which the TCI-State is applied by the UE only if the qcl-Type is configured as typeC or typeD. If the
referenceSignal is set to csi-rs and unifiedTCI-State Type is configured, either both cell and bwp-Id are present or both
cell and bwp-Id are absent. See TS 38.214 [19] clause 5.1.5.
referenceSignal
Reference signal with which quasi-collocation information is provided as specified in TS 38.214 [19] clause 5.1.5.
qcl-Type
QCL type as specified in TS 38.214 [19] clause 5.1.5.

In [7]3GPP TS 38.321 h50, relevant MAC CE information is quoted below.

### 6.1.3.13 Aperiodic CSI Trigger State Subselection MAC CE

The Aperiodic CSI Trigger State Subselection MAC CE is identified by a MAC subheader with LCID as specified in Table 6.2.1-1. It has a variable size consisting of following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in TS 38.212 [9]. The length of the BWP ID field is 2 bits;
Tᵢ: This field indicates the selection status of the Aperiodic Trigger States configured within aperiodicTriggerStateList, as specified in TS 38.331 [5]. T₀ refers to the first trigger state within the list, T₁ to the second one and so on. If the list does not contain entry with index i, MAC entity shall ignore the Tᵢ field. The Tᵢ field is set to 1 to indicate that the Aperiodic Trigger State i shall be mapped to the codepoint of the DCI CSI request field, as specified in TS 38.214 [7]. The codepoint to which the Aperiodic Trigger State is mapped is determined by its ordinal position among all the Aperiodic Trigger States with Tᵢ field set to 1, i.e. the first Aperiodic Trigger State with Tᵢ field set to 1 shall be mapped to the codepoint value 1, second Aperiodic Trigger State with Tᵢ field set to 1 shall be mapped to the codepoint value 2 and so on. The maximum number of mapped Aperiodic Trigger States is 63;
R: Reserved bit, set to 0.

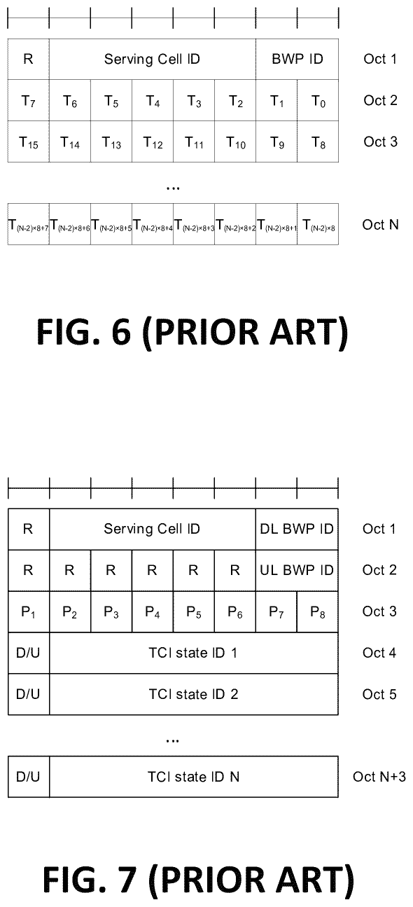

FIG. 6 is a reproduction of Figure 6.1.3.13-1: Aperiodic CSI Trigger State Subselection MAC CE, 3GPP TS 38.321 h50.

### 6.1.3.47 Unified TCI States Activation/Deactivation MAC CE

The Unified TCI States Activation/Deactivation MAC CE is identified by a MAC subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331 [5], this MAC CE applies to all the Serving Cells in the set simultaneousU-TCI-UpdateList1, simultaneousU-TCI-UpdateList2, simultaneousU-TCI-UpdateList3 or simultaneousU-TCI-UpdateList4, respectively;
DL BWP ID: This field indicates a DL BWP for which the MAC CE applies as the codepoint of the DCI bandwidth part indicator field as specified in TS 38.212 [9]. The length of the BWP ID field is 2 bits;
UL BWP ID: This field indicates a UL BWP for which the MAC CE applies as the codepoint of the DCI bandwidth part indicator field as specified in TS 38.212 [9]. If value of unifiedTCI-StateType in the Serving Cell indicated by Serving Cell ID is joint, this field is considered as the reserved bits. The length of the BWP ID field is 2 bits;
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as specified in TS 38.331 [5]. If D/U is set to 1, 7-bits length TCI state ID i.e. TCI-StateId as specified in TS 38.331 [5] is used. If D/U is set to 0, the most significant bit of TCI state ID is considered as the reserved bit and remainder 6 bits indicate the TCI-UL-State-Id as specified in TS 38.331 [5]. The maximum number of activated TCI states is 16;
R: Reserved bit, set to 0.

FIG. 7 is a reproduction of Fig. 6.1.3.47-1: Unified TCI state activation/deactivation MAC CE, from 3GPP TS 38.321 h50.

. . .

### 5.9 Activation/Deactivation of SCells

If the MAC entity is configured with one or more SCells, the network may activate and deactivate the configured SCells.

Upon configuration of an SCell, the SCell is deactivated unless the parameter sCellState is set to activated for the SCell by upper layers.

The configured SCell(s) is activated and deactivated by:
receiving the SCell Activation/Deactivation MAC CE described in clause 6.1.3.10;
receiving the Enhanced SCell Activation/Deactivation MAC CE described in clause 6.1.3.55;
configuring sCellDeactivationTimer timer per configured SCell (except the SCell configured with PUCCH, if any): the associated SCell is deactivated upon its expiry;
configuring sCellState per configured SCell: if configured, the associated SCell is activated upon SCell configuration;
receiving scg-State: the SCells of SCG are deactivated.

The MAC entity shall for each configured SCell:
1> if an SCell is configured with sCellState set to activated upon SCell configuration, or an SCell Activation/Deactivation MAC CE or an Enhanced SCell Activation/Deactivation MAC CE is received activating the SCell:
   2> if the SCell was deactivated prior to receiving this Enhanced SCell Activation/Deactivation MAC CE and a TRS is indicated for this SCell:
      3> indicate to lower layers the information regarding the TRS.
   2> if the SCell was deactivated prior to receiving this SCell Activation/Deactivation MAC CE or this Enhanced SCell Activation/Deactivation MAC CE; or
   2> if the SCell is configured with sCellState set to activated upon SCell configuration:
      3> if firstActiveDownlinkBWP-Id is not set to dormant BWP:
         4> activate the SCell according to the timing defined in TS 38.213 [6] for MAC CE activation and according to the timing defined in TS 38.133 [11] for direct SCell activation; i.e. apply normal SCell operation including:
         5> SRS transmissions on the SCell;
         5> CSI reporting for the SCell;
         5> PDCCH monitoring on the SCell;
         5> PDCCH monitoring for the SCell;
         5> PUCCH transmissions on the SCell, if configured.
      3> else (i.e. firstActiveDownlinkBWP-Id is set to dormant BWP):
         4> stop the bwp-InactivityTimer of this Serving Cell, if running.
      3> activate the DL BWP and UL BWP indicated by firstActiveDownlinkBWP-Id and firstActiveUplinkBWP-Id respectively.
   2> start or restart the sCellDeactivationTimer associated with the SCell according to the timing defined in TS 38.213 [6] for MAC CE activation and according to the timing defined in TS 38.133 [11] for direct SCell activation;
   2> if the active DL BWP is not the dormant BWP:
      3> (re-)initialize any suspended configured uplink grants of configured grant Type 1 associated with this SCell according to the stored configuration, if any, and to start in the symbol according to rules in clause 5.8.2;
      3> trigger PHR according to clause 5.4.6.
1> else if an SCell Activation/Deactivation MAC CE or an Enhanced SCell Activation/Deactivation MAC CE is received deactivating the SCell; or
1> if the sCellDeactivationTimer associated with the activated SCell expires; or
1> if the SCG associated with the activated SCell is deactivated:
   2> deactivate the SCell according to the timing defined in TS 38.213 [6];
   2> stop the sCellDeactivationTimer associated with the SCell;
   2> stop the bwp-InactivityTimer associated with the SCell;
   2> deactivate any active BWP associated with the SCell;
   2> clear any configured downlink assignment and any configured uplink grant Type 2 associated with the SCell respectively;
   2> clear any PUSCH resource for semi-persistent CSI reporting associated with the SCell;
   2> suspend any configured uplink grant Type 1 associated with the SCell;
   2> flush all HARQ buffers associated with the SCell;
   2> cancel, if any, triggered consistent LBT failure for the SCell.
1> if PDCCH on the activated SCell indicates an uplink grant or downlink assignment; or
1> if PDCCH on the Serving Cell scheduling the activated SCell indicates an uplink grant or a downlink assignment for the activated SCell; or
1> if a MAC PDU is transmitted in a configured uplink grant and LBT failure indication is not received from lower layers; or
1> if a MAC PDU is received in a configured downlink assignment:
   2> restart the sCellDeactivationTimer associated with the SCell.
1> if the SCell is deactivated:
   2> not transmit SRS on the SCell;
   2> not report CSI for the SCell;
   2> not transmit on UL-SCH on the SCell;
   2> not transmit on RACH on the SCell;
   2> not monitor the PDCCH on the SCell;
   2> not monitor the PDCCH for the SCell;
   2> not transmit PUCCH on the SCell.

HARQ feedback for the MAC PDU containing SCell Activation/Deactivation MAC CE or Enhanced SCell Activation/Deactivation MAC CE shall not be impacted by PCell, PSCell and PUCCH SCell interruptions due to SCell activation/deactivation in TS 38.133 [11].

When SCell is deactivated, the ongoing Random Access procedure on the SCell, if any, is aborted.
In [8]3GPP TS 38.213 h60, the following is provided.

### 10.3 PDCCH Monitoring Indication and Dormancy/Non-Dormancy Behaviour for SCells

A UE configured with DRX mode operation [11, TS 38.321] can be provided the following for detection of a DCI format 2_6 in a PDCCH reception on the PCell or on the SpCell [12, TS 38.331]
a PS-RNTI for DCI format 2_6 by ps-RNTI
a number of search space sets, by dci-Format2-6, to monitor PDCCH for detection of DCI format 2_6 on the active DL BWP of the PCell or of the SpCell according to a common search space as described in clause 10.1
a payload size for DCI format 2_6 by sizeDCI-2-6
a location in DCI format 2_6 of a Wake-up indication bit by ps-PositionDCI-2-6
   a ‘0’ value for the Wake-up indication bit, when reported to higher layers, indicates to not start the drx-onDurationTimer for the next long DRX cycle [11, TS 38.321]
   a ‘1’ value for the Wake-up indication bit, when reported to higher layers, indicates to start the drx-onDurationTimer for the next long DRX cycle [11, TS 38.321]
a bitmap, when the UE is provided a number of groups of configured SCells by dormancyGroupOutsideActiveTime, where
   the bitmap location is immediately after the Wake-up indication bit location
   the bitmap size is equal to the number of groups of configured SCells where each bit of the bitmap corresponds to a group of configured SCells from the number of groups of configured SCells
   a ‘0’ value for a bit of the bitmap indicates an active DL BWP, provided by dormantBWP-Id, for the UE [11, TS 38.321] for each activated SCell in the corresponding group of configured SCells
   a ‘1’ value for a bit of the bitmap indicates
      an active DL BWP, provided by firstOutsideActiveTimeBWP-Id, for the UE for each activated SCell in the corresponding group of configured SCells, if a current active DL BWP is the dormant DL BWP
      a current active DL BWP, for the UE for each activated SCell in the corresponding group of configured SCells, if the current active DL BWP is not the dormant DL BWP
   the UE sets the active DL BWP to the indicated active DL BWP
an offset by ps-Offset indicating a time, where the UE starts monitoring PDCCH for detection of DCI format 2_6 according to the number of search space sets, prior to a slot where the drx-onDurationTimer would start on the PCell or on the SpCell [11, TS 38.321]
   for each search space set, the PDCCH monitoring occasions are the ones in the first Tₛ slots indicated by duration, or Tₛ=1 slot if duration is not provided, starting from the first slot of the first Tₛ slots and ending prior to the start of drx-onDurationTimer.

If a UE is provided search space sets to monitor PDCCH for detection of DCI format 2_6 in the active DL BWP of the PCell or of the SpCell and the UE detects DCI format 2_6, the physical layer of a UE reports the value of the Wake-up indication bit for the UE to higher layers [11, TS 38.321] for the next long DRX cycle.

If a UE is provided search space sets to monitor PDCCH for detection of DCI format 2_6 in the active DL BWP of the PCell or of the SpCell and the UE does not detect DCI format 2_6, the physical layer of the UE does not report a value of the Wake-up indication bit to higher layers for the next long DRX cycle.

If a UE is provided search space sets to monitor PDCCH for detection of DCI format 2_6 in the active DL BWP of the PCell or of the SpCell and the UE
is not required to monitor PDCCH for detection of DCI format 2_6, as described in clauses 10, 11.1, 12, and in clause 5.7 of [11, TS 38.321] for all corresponding PDCCH monitoring occasions outside Active Time prior to a next long DRX cycle, or
does not have any PDCCH monitoring occasions for detection of DCI format 2_6 outside Active Time of a next long DRX cycle
   the physical layer of the UE reports a value of 1 for the Wake-up indication bit to higher layers for the next long DRX cycle.

If a UE is provided search space sets to monitor PDCCH for detection of DCI format 0_1 and DCI format 1_1 and if one or both of DCI format 0_1 and DCI format 1_1 include a SCell dormancy indication field,
the SCell dormancy indication field is a bitmap with size equal to a number of groups of configured SCells, provided by dormancyGroupWithinActiveTime,
each bit of the bitmap corresponds to a group of configured SCells from the number of groups of configured Scells
if the UE detects a DCI format 0_1 or a DCI format 1_1 that does not include a carrier indicator field, or detects a DCI format 0_1 or DCI format 1_1 that includes a carrier indicator field with value equal to 0, and if the DCI format 0_1 does not indicate UL grant Type 2 release nor deactivate semi-persistent CSI report(s) on PUSCH, or if the DCI format 1_1 does not indicate SPS PDSCH release
   a ‘0’ value for a bit of the bitmap indicates an active DL BWP, provided by dormantBWP-Id, for the UE for each activated SCell in the corresponding group of configured SCells
   a ‘1’ value for a bit of the bitmap indicates
      an active DL BWP, provided by firstWithinActiveTimeBWP-Id, for the UE for each activated SCell in the corresponding group of configured SCells, if a current active DL BWP is the dormant DL BWP
      a current active DL BWP, for the UE for each activated SCell in the corresponding group of configured SCells, if the current active DL BWP is not the dormant DL BWP
   the UE sets the active DL BWP to the indicated active DL BWP

If an active DL BWP provided by dormantBWP-Id for a UE on an activated SCell is not a default DL BWP for the UE on the activated SCell, as described in clause 12, the BWP inactivity timer is not used for transitioning from the active DL BWP provided by dormantBWP-Id to the default DL BWP on the activated SCell.

In New Radio (NR) Rel-18, Coherent Joint Transmission (CJT) is introduced for improving spectrum efficiency with assumption of ideal synchronization and backhaul among multiple Transmission/Reception Points (TRPs). The number of the multiple TRPs could be up to 4 and with up to 2 (enhanced) unified Transmission Configuration Indicator (TCI) states. CJT could be one scheme that two TRPs use/utilize a same time-frequency resource by a beam or source Reference Signal (RS) associated with the up to 2 unified TCI states. CJT could be considered as one spatial domain multiplexing scheme. Based on a User Equipment's (UE's) capability, the network node could configure one or two unified TCI state(s). Due to characteristics of spatial multiplexing, time-frequency alignment between TRPs is necessary. That is, once synchronization is not well aligned (or a delay between two TRPs due to non-ideal backhaul), the performance would degrade.

Though Rel-18 applies an assumption that ideal synchronization for simple design of CJT, the industry is requiring to deploy CJT for real world use, which non-ideal synchronization and non-ideal backhaul among TRPs typically happens. Preferably in certain embodiments, when a network vendor deploys inter-site for one or more TRPs which is more aligned with real world communication between the UE and each of one or more different TRPs is typically associated with a different Doppler offset and time offset. Preferably in certain embodiments, non-ideal backhaul between TRPs may be considered together. A network node side's pre-compensation for time and/or frequency (and/or phase offset) between TRPs may be out of date. Thus, performance of CJT will be degraded, and a new design for UE-assisted CJT calibration will be needed. Preferably in certain embodiments, with UE-assisted CJT calibration, a network node could perform pre-compensation to achieve time and/or frequency alignment (synchronization). Preferably with UE-assisted CJT calibration, CJT operation for a Physical Downlink Shared Channel (PDSCH) to the UE could leverage for better performance.

In NR Rel-19, since the UE is the very first target to know the Downlink (DL) channel condition, people consider event triggered reporting for beam reporting. Besides, event triggered reporting needs a new design in NR Rel-19. Event triggered reporting without comprising receiving a signal from a network node to trigger a reporting. Preferably in certain embodiments, event triggered reporting could be used for mobility or beam reporting (e.g., Layer 1 (L1)-Reference Signal Received Power (RSRP), L1-Signal-to-Interference-Plus-Noise Ratio (SINR) or L3-RSRP, which is determined with a long term average), or CJT calibration reporting.

Preferably in certain embodiments, event triggered reporting may need a new design for when to trigger such reporting. Preferably in certain embodiments, event triggered reporting could be transmitted via Uplink Control Information (UCI) or Medium Access Control (MAC) Control Element (CE). Preferably in certain embodiments, an example scenario is deployment of a serving cell comprising a dormant Bandwidth Part (BWP) and non-dormant BWP. Preferably in certain embodiments, when the UE is indicated from the dormant BWP to the non-dormant BWP (e.g., there is DL or Uplink (UL) data arrival), due to a power saving state when the UE is in dormant BWP, information for a beam and/or time/frequency/phase synchronization may be insufficient or out of date. Without this information, for example, CJT-PDSCH deployed in the real world may have worse performance since time/frequency/phase synchronization is not pre-compensated accurately on the network side. For another example, without this information, Frequency Range 2 (FR2) deployment may be problematic since beam change is frequent in the FR2 scenario.

Throughout the present disclosure, “event triggered reporting”, “UE triggered reporting”, “condition triggered reporting” or “UE-initiated reporting” could be interchangeable.

Throughout the present disclosure, beam could be replaced by “TCI state”, “reference signal”, “Quasi Co-Location (QCL) assumption”, or “spatial filter”.

Preferably in certain embodiments, the UE could perform measurement time offset/frequency offset/phase offset associated with CJT calibration based on one or more RSs/channels. Preferably in certain embodiments, the one or more RSs/channels comprise a Demodulation Reference Signal (DMRS) associated with Physical Downlink Control Channel (PDCCH) indicating target change in the UE side.

This concept is to trigger one or more reportings based on one or more conditions met. The one or more reportings could comprise any one or any combination of CJT calibration reporting, (UE triggered/event triggered) beam reporting. Preferably in certain embodiments, the one or more conditions correspond to a status change (e.g., Secondary Cell (SCell) from deactivated to activated, dormant BWP to non-dormant BWP, cell-specific non-active time to cell-specific active time (associated with Network Energy Saving (NES) mechanism), RRC inactive state to RRC connected state, and/or a better measurement result). Preferably in certain embodiments, the UE could transmit the one or more reportings in one resource and transmit Power Headroom Report (PHR) reporting in another resource. Preferably in certain embodiments, the one resource and the another resource are separated in different symbols (in same TTI) or alternatively in different TTIs.

Preferably in certain embodiments, the UE receives a first Downlink Control Information (DCI) indicating entering a dormant BWP for a serving cell. Preferably in certain embodiments, the UE would change the active DL BWP from non-dormant to dormant BWP for the serving cell. Preferably in certain embodiments, the dormant BWP corresponds to DL and/or UL BWP of the serving cell. Preferably in certain embodiments, when an active DL BWP corresponds to a dormant BWP, the UE assumes or considers the associated UL BWP as a dormant BWP. Preferably in certain embodiments, paired or associated UL active BWP to DL BWP, which is dormant, is also or corresponds to a dormant BWP. Preferably in certain embodiments, when the UE is in a dormant BWP of the serving cell (i.e., called the BWP in these sentences), the UE stops bwp-InactivityTimer of this serving cell, does not monitor Physical Downlink Control Channel (PDCCH) on the BWP, does not monitor PDCCH for the BWP, does not receive DL-Synchronization Channel (SCH) on the BWP, does not report Channel State Information (CSI) on the BWP, does not transmit UL-SCH on the BWP, does not transmit Random Access Channel (RACH) on the BWP, not transmit Physical Uplink Control Channel (PUCCH) on the BWP. Preferably in certain embodiments, the UE receives a second DCI indicating leaving a dormant BWP for a serving cell. Preferably in certain embodiments, the UE is configured by RRC with one dormant BWP for a serving cell. Preferably in certain embodiments, the serving cell corresponds to a secondary cell (e.g., SCell). Preferably in certain embodiments, in response to the second DCI (or in response to the second DCI indicating leaving dormant BWP), the UE triggers the one or more (UE-initiated or event triggered) reporting. Preferably in certain embodiments, due to the second DCI indicating leaving dormant BWP, the UE triggers one or more (UE-initiated or event triggered) reportings.

Preferably in certain embodiments, in response to the triggering, the UE would attempt to transmit the one or more triggered (UE-initiated or event triggered) reportings. Preferably in certain embodiments, the one or more triggered (UE-initiated or event triggered) reportings are associated with at least the serving cell (or the one or more triggered (UE-initiated or event triggered) reportings comprising reporting of at least the serving cell). Alternatively in certain embodiments, the one or more triggered (UE-initiated or event triggered) reportings are associated with a (serving) cell group (e.g., Master Cell Group (MCG) or Secondary Cell Group (SCG)) comprising the serving cell. Alternatively in certain embodiments, the one or more triggered (UE-initiated or event triggered) reportings are associated with all configured serving cell groups (one of the all configured serving cell groups comprising the serving cell). Alternatively or additionally, the one or more triggered (UE-initiated or event triggered) reportings are not associated with the (serving) cell group (e.g., MCG or SCG) not comprising the serving cell. Preferably in certain embodiments, the one or more triggered (UE-initiated or event triggered) reportings are (triggered) in response to at least those serving cells which the UE changes status from dormant BWP to non-dormant BWP (or in response to at least those serving cells which the UE receives second DCIs for indicating non-dormant BWPs). Preferably in certain embodiments, the one or more triggered (UE-initiated or event triggered) reportings are without reporting associated with non-impacted serving cell(s) which is without status change from dormant BWP to non-dormant BWP.

Preferably in certain embodiments, the one or more triggered (UE-initiated or event triggered) reportings are without reporting information of serving cell(s) associated with dormant BWP (or associated with (already) non-dormant BWP without receiving second DCI for indicating non-dormant (in this time)). The serving cell(s) may be configured with uplink. Alternatively in certain embodiments, the serving cell(s) may not be configured with uplink. Preferably in certain embodiments, the serving cell(s) may be configured with DL BWP or DL dormant BWP. Preferably in certain embodiments, the serving cell(s) may correspond to DL only operation. Preferably in certain embodiments, the serving cell(s) may be configured with at least DL BWP.

Preferably in certain embodiments, the serving cell(s) is not configured with UL BWP. Preferably in certain embodiments, the serving cell(s) is not configured with Physical Uplink Shared Channel(s) (PUSCH(s)).

Preferably in certain embodiments, the serving cell(s) is not configured with PUSCH(s) or PUCCH(s) or Sounding Reference Signal(s) (SRS(s)). Preferably in certain embodiments, the serving cell(s) is not configured with UL resource(s) for determining type-1 PHR reporting. In one example, a concerned transmitted direction for triggering one or more triggered (UE-initiated or event triggered) reportings is different than the transmitted direction for triggering PHR reporting. Alternatively in certain embodiments, the concerned transmitted direction for triggering one or more triggered (UE-initiated or event triggered) reportings is the same as the transmitted direction for triggering PHR reporting.

Preferably in certain embodiments, one or more further conditions for triggering the one or more (UE-initiated or event triggered) reportings may be whether there is a configured downlink resource in or associated with the non-dormant BWP. Preferably in certain embodiments, when at least the UE is configured with a configured downlink resource in or associated with the non-dormant BWP, the UE triggers the one or more (UE-initiated or event triggered) reportings. Preferably in certain embodiments, when the UE is NOT configured with the configured downlink resource in or associated with the non-dormant BWP, the UE does not trigger the one or more (UE-initiated or event triggered) reportings. Preferably in certain embodiments, a downlink resource corresponds to a Control Resource Set (CORESET) configuration, and/or PDSCH configuration, Synchronization Signal (SS)/Physical Broadcast Channel (PBCH) reception. Preferably in certain embodiments, downlink resource corresponds to configuration of the DL BWP, and/or the initial DL BWP.

Alternatively and/or preferably in certain embodiments, one or more further conditions for triggering the one or more (UE-initiated or event triggered) reportings may be whether there is a configured downlink (operation) in or associated with the non-dormant BWP (or whether there is a configured downlink (operation) for the serving cell or whether there is a configured downlink (operation) for the non-dormant BWP or whether there is a configured downlink (operation) for a MAC entity associated with the serving cell).

Preferably in certain embodiments, when at least the UE is configured with downlink (operation) in or associated with the non-dormant BWP (or when at least the UE is configured with downlink (operation) for the serving cell or when there is a configured downlink (operation) for the non-dormant BWP or when there is a configured downlink (operation) for a MAC entity associated with the serving cell), the UE triggers the one or more (UE-initiated or event triggered) reportings. Preferably in certain embodiments, when the UE is NOT configured with downlink (operation) in or associated with the non-dormant BWP (or when at least the UE is NOT configured with downlink (operation) for the serving cell or when there is NO configured downlink (operation) for the non-dormant BWP or when there is NO configured downlink (operation) for a MAC entity associated with the serving cell), the UE does not trigger the one or more (UE-initiated or event triggered) reportings.

Alternatively and/or preferably in certain embodiments, no matter whether the UE is configured with downlink operation for the serving cell (or configured with downlink operation for the non-dormant BWP or configured with downlink operation for the MAC entity associated with the serving cell) or not, the UE triggers the one or more (UE-initiated or event triggered) reportings. Preferably in certain embodiments, the serving cell is configured in a MAC entity configured with downlink (operation).

Preferably in certain embodiments, one or more further conditions for triggering the one or more (UE-initiated or event triggered) reportings concerning a serving cell that is configured with downlink (or configured with uplink) (or configured with both downlink and uplink) could be applied or combined with any of a triggering cause mentioned throughout the disclosure.

Preferably in certain embodiments, one or more further conditions for triggering the one or more (UE-initiated or event triggered) reportings may be whether there is a configured uplink resource in or associated with the non-dormant BWP. Preferably in certain embodiments, when at least the UE is configured with a configured uplink resource in or associated with the non-dormant BWP, the UE triggers the one or more (UE-initiated or event triggered) reportings. Preferably in certain embodiments, when the UE is NOT configured with a configured uplink resource in or associated with the non-dormant BWP, the UE does not trigger the one or more (UE-initiated or event triggered) reportings.

Alternatively and/or preferably in certain embodiments, one or more further conditions for triggering the one or more (UE-initiated or event triggered) reportings may be whether there is a configured uplink (operation) in or associated with the non-dormant BWP (or whether there is configured uplink (operation) for the serving cell or whether there is a configured uplink (operation) for the non-dormant BWP or whether there is a configured uplink (operation) for a MAC entity associated with the serving cell). Preferably in certain embodiments, when at least the UE is configured with an uplink (operation) in or associated with the non-dormant BWP (or when at least UE is a configured with uplink (operation) for the serving cell or when there is a configured uplink (operation) for the non-dormant BWP or when there is a configured uplink (operation) for a MAC entity associated with the serving cell), the UE triggers the one or more (UE-initiated or event triggered) reportings. Preferably in certain embodiments, when the UE is NOT configured with an uplink (operation) in or associated with the non-dormant BWP (or when at least the UE is NOT configured with an uplink (operation) for the serving cell or when there is NO configured uplink (operation) for the non-dormant BWP or when there is NO configured uplink (operation) for a MAC entity associated with the serving cell), the UE does not trigger the one or more (UE-initiated or event triggered) reportings.

Alternatively and/or preferably in certain embodiments, no matter whether the UE is configured with an uplink operation for the serving cell (or configured with an uplink operation for the non-dormant BWP or configured with an uplink operation for the MAC entity associated with the serving cell) or not, the UE triggers the one or more (UE-initiated or event triggered) reportings. Preferably in certain embodiments, the serving cell is configured in a MAC entity configured with an uplink (operation).

Preferably in certain embodiments, the UE is configured with at least one Lower Layer (L1/L2) Triggered Mobility (LTM) candidate cell configuration. Preferably in certain embodiments, the UE could be configured with a set of TCI states associated with the at least one LTM candidate cell. Preferably in certain embodiments, once the UE receives a signal for activating and/or indicating one TCI state (among the set of TCI states), the UE triggers one or more (UE-initiated or event triggered) reportings. Preferably in certain embodiments, such TCI state activation or TCI state indication for the at least one LTM candidate cell corresponds to one triggering cause. Preferably in certain embodiments, the triggering cause may be associated with a candidate cell other than the (current) serving cell. Preferably in certain embodiments, one or more specific configurations (associated with UE-initiated or event triggered reporting) could be configured per LTM candidate cell. Preferably in certain embodiments, the one or more specific configurations (associated with UE-initiated or event triggered reporting) associated with one LTM candidate cell is not allowed to be used or applied before the LTM candidate cell becomes a serving cell. Alternatively in certain embodiments, the one or more specific configurations (associated with UE-initiated or event triggered reporting) associated with one LTM candidate cell could be used or applied after the LTM candidate cell becomes a serving cell.

Preferably in certain embodiments, a specific configuration (associated with UE-initiated or event triggered reporting) could be used or applied means or corresponds that the UE (could) trigger one or more reportings based on the one or more specific configurations. Preferably in certain embodiments, before the LTM candidate cell becomes a serving cell, the UE triggers one or more reportings based on a first one or more triggering causes (e.g., upon receiving activation for LTM TCI state or indication for LTM TCI state).

Preferably in certain embodiments, after the LTM candidate cell becomes a serving cell, the UE triggers one or more reportings based on a second one or more triggering causes (e.g., one or more specific configurations associated with UE-initiated or event triggered reporting).

Preferably in certain embodiments, the UE receives a signal to activate an SCell. Preferably in certain embodiments, in response to the signal (or in response to the indication of the signal), the UE triggers the one or more (UE-initiated or event triggered) reportings. Preferably in certain embodiments, due to the signal activating a secondary cell, the UE triggers one or more (UE-initiated or event triggered) reportings.

Preferably in certain embodiments, in response to the triggering, the UE would attempt to transmit the one or more triggered (UE-initiated or event triggered) reportings. Preferably in certain embodiments, the one or more triggered (UE-initiated or event triggered) reportings are associated with at least the secondary cell (or the one or more triggered (UE-initiated or event triggered) reportings comprise reporting of at least the secondary cell). Alternatively in certain embodiments, the one or more triggered (UE-initiated or event triggered) reportings are associated with a (serving) cell group (e.g., MCG or SCG) comprising the secondary cell. Alternatively in certain embodiments, the one or more triggered (UE-initiated or event triggered) reportings are associated with all configured serving cell groups (one of the all configured serving cell groups comprising the secondary cell). Alternatively or additionally, the one or more triggered (UE-initiated or event triggered) reportings are not associated with the (serving) cell group (e.g., MCG or SCG) not comprising the serving cell. Preferably in certain embodiments, the one or more triggered (UE-initiated or event triggered) reportings are (triggered) in response to at least those serving cells (comprising the secondary cell) which the UE has received a signal for cell activation. Preferably in certain embodiments, the one or more triggered (UE-initiated or event triggered) reportings is without reporting associated with non-impacted serving cell(s) which is without a status change or without receiving a signal for cell activation. Preferably in certain embodiments, the one or more triggered (UE-initiated or event triggered) reportings are without reporting associated with a deactivated cell (or associated with an (already) activated cell without receiving a signal for cell activation (in this time)). The secondary cell may be configured with uplink. Alternatively in certain embodiments, the secondary cell may not be configured with uplink.

Preferably in certain embodiments, one or more further conditions for triggering the one or more (UE-initiated or event triggered) reportings may be whether there is a configured uplink resource in or associated with the secondary cell. Preferably in certain embodiments, when at least the UE is configured with a configured uplink resource in or associated with the secondary cell, the UE triggers the one or more (UE-initiated or event triggered) reportings. Preferably in certain embodiments, when the UE is NOT configured with a configured uplink resource in or associated with the secondary cell, the UE does not trigger the one or more (UE-initiated or event triggered) reportings.

Alternatively and/or preferably in certain embodiments, one or more further conditions for triggering the one or more (UE-initiated or event triggered) reportings may be whether there is a configured uplink (operation) in or associated with the secondary cell (or whether there is a configured uplink (operation) for the secondary cell or whether there is a configured uplink (operation) for a MAC entity associated with the secondary cell). Preferably in certain embodiments, when at least the UE is configured with an uplink (operation) in or associated with the secondary cell (or when at least the UE is configured with an uplink (operation) for the secondary cell or when there is a configured uplink (operation) for a MAC entity associated with the secondary cell), the UE triggers the one or more (UE-initiated or event triggered) reportings.

Preferably in certain embodiments, when the UE is NOT configured with an uplink (operation) in or associated with the secondary cell (or when at least the UE is NOT configured with an uplink (operation) for the secondary cell or when there is NO configured uplink (operation) for a MAC entity associated with the secondary cell), the UE does not trigger the one or more (UE-initiated or event triggered) reportings.

Alternatively and/or preferably in certain embodiments, no matter whether the UE is configured with an uplink operation for the secondary cell (or configured with an uplink operation for a MAC entity associated with the secondary cell) or not, the UE triggers the one or more (UE-initiated or event triggered) reportings. Preferably in certain embodiments, the secondary cell is configured in a MAC entity configured with an uplink (operation).

Preferably in certain embodiments, a first active DL BWP of the secondary cell is not configured as a dormant BWP. Preferably in certain embodiments, one or more further conditions for triggering the one or more (UE-initiated or event triggered) reportings may be whether a first active DL BWP of the secondary cell is NOT configured as a dormant BWP. Preferably in certain embodiments, when a first active DL BWP of the secondary cell is configured as a dormant BWP, the UE does not trigger the one or more (UE-initiated or event triggered) reportings (for at least the secondary cell). Preferably in certain embodiments, when at least a first active DL BWP of the secondary cell is configured as a non-dormant BWP, the UE triggers the one or more (UE-initiated or event triggered) reportings (for at least the secondary cell). Preferably in certain embodiments, a “first active DL BWP” corresponds to a BWP in the secondary cell, which the BWP is associated with firstActiveDownlinkBWP-Id.

Preferably in certain embodiments, in short, when receiving the signal activating the secondary cell, the first active DL BWP in or associated with or configured in the secondary cell is NOT or does NOT correspond to a dormant BWP, the UE triggers the one or more (UE-triggered or event triggered) reportings.

Preferably in certain embodiments, the UE receives a signal to activate an SCG. Preferably in certain embodiments, the UE may receive the signal in one serving cell in a (current) MCG. Preferably in certain embodiments, this status change is from nothing to a (newly) added one. Preferably in certain embodiments, the UE could be without an SCG configuration or without communication with the serving cell in another Cell Group (CG) (in addition to the current MCG). Preferably in certain embodiments, in response to the signal (or in response to the indication of the signal), the UE triggers the one or more (UE-initiated or event triggered) reportings. Preferably in certain embodiments, the one or more (UE-initiated or event triggered) reportings at least comprise reporting information associated with a set of serving cells in the secondary cell group.

Preferably in certain embodiments, in this triggering cause (e.g., upon receiving activation of SCG), the UE triggers and reports all reporting information associated with serving cell(s) in the secondary cell group.

Preferably in certain embodiments, in this triggering cause (e.g., upon receiving activation of SCG), the UE triggers and reports one or more reporting information associated with serving cell(s) in the secondary cell group, wherein a number of the serving cell(s) corresponds to serving cell(s) associated with or configured with UE-initiated reporting. Alternatively in certain embodiments, the UE may, based on whether the SCG is configured with UE-initiated reporting, to determine whether to trigger and transmit UE-initiated reporting associated with serving cell(s) in the SCG. Preferably in certain embodiments, in this scenario, the UE would trigger and transmit reporting information associated with all serving cell(s) in the SCG (upon receiving the signal or upon indication of the received signal). Preferably in certain embodiments, due to the signal activating a SCG, the UE triggers one or more (UE-initiated or event triggered) reportings. Preferably in certain embodiments, in response to the triggering, the UE would attempt to transmit the one or more triggered (UE-initiated or event triggered) reportings. Preferably in certain embodiments, the one or more triggered (UE-initiated or event triggered) reportings are associated with at least the serving cell(s) in the SCG (or the one or more triggered (UE-initiated or event triggered) reportings comprise reporting of at least the serving cell(s) in the SCG). Alternatively in certain embodiments, the one or more triggered (UE-initiated or event triggered) reportings are associated with all configured serving cell groups comprising SCG. Preferably in certain embodiments, the one or more triggered (UE-initiated or event triggered) reportings are without reporting associated with non-impacted serving cell(s) which is without status change. Preferably in certain embodiments, in this example, the UE triggers (and transmits) reporting information associated with SCG (instead of MCG), and/or the UE does not trigger (and transmits) reporting information associated with MCG (due to this triggering cause). Preferably in certain embodiments, the one or more triggered (UE-initiated or event triggered) reportings are without reporting associated with a deactivated cell (or associated with (already) activated cell without receiving a signal for cell activation (in this time)). Preferably in certain embodiments, the one or more triggered (UE-initiated or event triggered) reportings are with or comprise reporting information associated with a deactivated cell. The secondary cell may be configured with uplink.

Alternatively in certain embodiments, the secondary cell may not be configured with uplink.

Preferably in certain embodiments, the UE receives a signal to add or change Primary SCG Cell/Primary Secondary Cell (PSCell) (in a secondary cell group (SCG)). Preferably in certain embodiments, the UE may receive the signal in one serving cell in the (current) MCG. Preferably in certain embodiments, this status change is from nothing to a (newly) added one or from a first PSCell to a second PSCell. Preferably in certain embodiments, the UE could be without SCG configuration or without communication with the serving cell in another CG (in addition to the current MCG). Preferably in certain embodiments, in response to the signal (or in response to the indication of the signal), the UE triggers the one or more (UE-initiated or event triggered) reportings. Preferably in certain embodiments, the one or more (UE-initiated or event triggered) reportings at least comprise reporting information associated with a set of serving cells in the secondary cell group. Alternatively in certain embodiments, the one or more (UE-initiated or event triggered) reportings at least comprise reporting information associated with the second PSCell in the secondary cell group. Alternatively in certain embodiments, the one or more (UE-initiated or event triggered) reportings comprise only reporting information associated with the second PSCell in the secondary cell group. Preferably in certain embodiments, in this triggering cause (e.g., upon receiving the signal to add or change PSCell), the UE triggers and reports all reporting information associated with serving cell(s) in the secondary cell group.

Preferably in certain embodiments, in this triggering cause (e.g., upon receiving the signal to add or change PSCell), the UE triggers and reports one or more reporting information associated with (all or a subset of) serving cell(s) in the secondary cell group, wherein a number of the (all or a subset of) serving cell(s) corresponds to serving cell(s) associated with or configured with UE-initiated reporting. Preferably in certain embodiments, the subset of serving cell(s) corresponds to activated cell(s) in the SCG. Preferably in certain embodiments, the UE does not trigger or transmit reporting information associated with deactivated cell(s) or a serving cell which is in a dormant BWP. Preferably in certain embodiments, in this example, the UE may not trigger UE-initiated reporting when the SCG is deactivated (even if the UE receives the signal indicating to add or change of PSCell). Preferably in certain embodiments, whether a serving cell is in a dormant BWP and/or whether a serving cell is not an activated cell could correspond to the one or more further triggering conditions for one or more triggered (UE-initiated or event triggered) reportings, throughout the disclosure.

For example, when one triggering cause is met, the UE may not trigger triggered reporting for one serving cell which is in a dormant BWP or is not activated. Alternatively in certain embodiments, the UE may, based on whether the SCG is being configured with UE-initiated reporting, to determine whether to trigger and transmit UE-initiated reporting associated with the serving cell(s) in the SCG. Preferably and/or alternatively in certain embodiments, the UE may, based on whether the PSCell being configured with UE-initiated reporting, to determine whether to trigger and transmit UE-initiated reporting associated with the PSCell. Preferably in certain embodiments, in this scenario, the UE would trigger and transmit reporting information associated with all serving cell(s) in the SCG (upon receiving the signal or upon indication of the received signal). Preferably in certain embodiments, due to the signal to add or change the PSCell, the UE triggers one or more (UE-initiated or event triggered) reportings. Preferably in certain embodiments, in response to the triggering, the UE would attempt to transmit the one or more triggered (UE-initiated or event triggered) reportings.

Preferably in certain embodiments, the one or more triggered (UE-initiated or event triggered) reportings are associated with at least (or only) the PSCell in the SCG (or the one or more triggered (UE-initiated or event triggered) reportings comprise reporting of at least the PSCell in the SCG). Alternatively in certain embodiments, the one or more triggered (UE-initiated or event triggered) reportings are associated with all serving cell(s) comprising the PSCell in the SCG (or the one or more triggered (UE-initiated or event triggered) reportings comprise reporting of at least the PSCell in the SCG). Alternatively in certain embodiments, the one or more triggered (UE-initiated or event triggered) reportings are associated with all configured serving cell groups. Preferably in certain embodiments, the one or more triggered (UE-initiated or event triggered) reportings are without reporting associated with non-impacted serving cell(s) which is without a status change. Preferably in certain embodiments, in this example, the UE triggers (and transmits) reporting information associated with the SCG (instead of MCG), and/or the UE does not trigger (and transmits) reporting information associated with the MCG (due to this triggering cause). Preferably in certain embodiments, the one or more triggered (UE-initiated or event triggered) reportings are without reporting associated with a deactivated cell (or associated with the (already) activated cell without receiving the signal for cell activation (in this time)). Preferably in certain embodiments, the one or more triggered (UE-initiated or event triggered) reportings are with or comprise reporting information associated with a deactivated cell. The PSCell may be configured with an uplink. Alternatively in certain embodiments, the PSCell may not be configured with an uplink.

Preferably in certain embodiments, the UE receives a signal to handover or change the (current used) cell group. Preferably in certain embodiments, indication of the signal could be that changing a first MCG to the second MCG, a first SCG (if there is current used SCG) to a second SCG, a secondary SCG. Preferably in certain embodiments, the UE may receive the signal in one serving cell in the (current) master cell group (MCG). Preferably in certain embodiments, in response to the signal (or in response to the indication of the signal), the UE triggers the one or more (UE-initiated or event triggered) reportings. Preferably in certain embodiments, the one or more (UE-initiated or event triggered) reportings at least comprise reporting information associated with a set of serving cells in the newly changed cell group. Preferably in certain embodiments, in this triggering cause (e.g., upon receiving modification or change of current CG), the UE triggers and reports all reporting information associated with serving cell(s) in the new cell group. Preferably in certain embodiments, in this triggering cause (e.g., upon receiving modification or change of current CG), the UE triggers and reports one or more reporting information associated with serving cell(s) in the new cell group, wherein a number of the serving cell(s) correspond to serving cell(s) associated with or configured with UE-initiated reporting. Alternatively in certain embodiments, the UE may, based on whether a new CG is being configured with UE-initiated reporting, to determine whether to trigger and transmit UE-initiated reporting associated with serving cell(s) in the new CG. Preferably in certain embodiments, in this scenario, the UE would trigger and transmits reporting information associated with all serving cell(s) in the new CG (upon receiving the signal or upon indication of the received signal). Preferably in certain embodiments, due to the signal changing or modifying a CG, the UE triggers one or more (UE-initiated or event triggered) reportings. Preferably in certain embodiments, in response to the triggering, the UE would attempt to transmit the one or more triggered (UE-initiated or event triggered) reportings. Preferably in certain embodiments, the one or more triggered (UE-initiated or event triggered) reportings are associated with at least serving cell(s) in the new CG (or the one or more triggered (UE-initiated or event triggered) reportings comprise reporting of at least serving cell(s) in the new CG). Alternatively in certain embodiments, the one or more triggered (UE-initiated or event triggered) reportings are associated with all configured serving cell groups (one of all configured serving cell groups comprising the new CG). Preferably in certain embodiments, the one or more triggered (UE-initiated or event triggered) reportings do not comprise reporting information associated with the replaced or old CG. Preferably in certain embodiments, the one or more triggered (UE-initiated or event triggered) reportings are without reporting associated with non-impacted serving cell(s) which is without a status change. Preferably in certain embodiments, in this example, the UE triggers (and transmits) reporting information associated with the SCG (instead of MCG), and/or the UE does not trigger (and transmits) reporting information associated with the MCG (due to this triggering cause). Preferably in certain embodiments, the one or more triggered (UE-initiated or event triggered) reportings are without reporting associated with a deactivated cell (or associated with (already) activated cell without receiving cell activation (in this time)). Preferably in certain embodiments, the one or more triggered (UE-initiated or event triggered) reportings are with or comprise reporting information associated with the deactivated cell. The secondary cell may be configured with an uplink. Alternatively in certain embodiments, the secondary cell may not be configured with an uplink.

Preferably in certain embodiments, the UE could apply different handling for adding a CG (or replacing a whole CG) or modifying one or more serving cells in a current CG. Preferably in certain embodiments, when the UE receives a signal indicating adding or replacing a whole CG, the triggered one or more reportings comprise reporting information associated with all serving cell(s) in the new (adding) CG.

Preferably in certain embodiments, in this scenario (but not limited to this scenario), even at least a first serving cell in the new (adding) CG is deactivated or in a dormant BWP, the one or more triggered reportings comprise reporting information associated with the first serving cell. Alternatively in certain embodiments, the UE (still does not) trigger (and transmit) the reporting information associated with the first serving cell.

Preferably in certain embodiments, when the UE receives a signal indicating modifying one or more serving cells (including replacing a second serving cell to a third serving cell, adding a fourth serving cell), the triggered one or more reportings comprise reporting information associated with only or merely the third serving cell or the fourth serving cell. Preferably in certain embodiments, in this scenario (but not limited to this scenario), even at least the third serving cell or the fourth serving cell is deactivated or in a dormant BWP, the one or more triggered reportings comprise reporting information associated with the third serving cell or the fourth serving cell. Alternatively in certain embodiments, the UE (still does not) trigger (and transmit) the reporting information associated with the second serving cell.

Alternatively in certain embodiments, no matter whether adding CG (or replacing a whole CG) or modifying one or more serving cells in a current CG, the UE applies same handling for UE-initiated or event triggered reporting.

Preferably in certain embodiments, a triggering cause could be configured per CG.

Preferably in certain embodiments, one CG could be configured with or specified with one or more triggering causes.

Preferably in certain embodiments, a different CG corresponds to an independently set of triggering cause (could comprise one or more triggering causes).

Preferably in certain embodiments, based on each CG's configured triggering cause, the UE could determine whether to trigger one or more reportings for a corresponding CG.

Preferably in certain embodiments, throughout the present disclosure, one or more triggered (UE-initiated or event triggered) reportings comprise reporting information associated with a new target (e.g., serving cell, (serving) cell group).

Preferably in certain embodiments, throughout the present disclosure, one or more triggered (UE-initiated or event triggered) reportings comprise reporting information associated with a new target (e.g., serving cell, (serving) cell group) and an old target.

Preferably in certain embodiments, based on a triggering cause is configured from a specific configuration (associated with UE-initiated or event triggered reporting) or specified, the UE determines whether to include reporting information associated with both candidate targets (e.g., candidate RS, TCI state) and currently used/indicated target (e.g., used/indicated TCI state or RS). Preferably in certain embodiments, for a triggering cause due to a specific configuration, the UE includes reporting information associated with both a candidate target and a currently used/indicated target. Alternatively in certain embodiments, for a triggering cause due to a specific configuration, the UE includes reporting information associated with a candidate target. Preferably in certain embodiments, for a specified triggering cause, the UE includes reporting information associated with both a candidate target and a currently used/indicated target. Alternatively in certain embodiments, for a specified triggering cause, the UE includes reporting information associated with a candidate target. Preferably in certain embodiments, whether to include reporting information associated with both a candidate target and a used/indicated target is based on a network node's configuration. Preferably in certain embodiments, a network node's configuration providing to the UE could be one bit to indicate whether to include both. Preferably in certain embodiments, a network node's configuration providing to the UE could be one or more ranges of an RSRP level or an SINR level. Preferably in certain embodiments, in some range of RSRP levels or SINR levels, gain between a candidate target and a used target is not significant, the UE could report it to the network node. Preferably in certain embodiments, the network node has final decision power to decide whether to indicate the UE to change the indicated beam. Alternatively in certain embodiments, the UE could set whether to include reported information associated with the used/indicated target or not.

Preferably in certain embodiments, a different purpose of UE-initiated or event triggered reporting may have a different format for reporting. Preferably in certain embodiments, a first purpose (e.g., CJT calibration reporting) may correspond to a first format for reporting. Preferably in certain embodiments, the first format may include reporting information associated with a used/indicated target and a candidate target.

Preferably in certain embodiments, a second purpose (e.g., beam reporting) may correspond to a second format for reporting. Preferably in certain embodiments, the second format may include reporting information associated with a candidate target (only).

Throughout the present disclosure, reporting information associated with one target means or corresponds or may include measurement results associated with the one target (or based on the one target), information of the one target (e.g., ID of the one target), and/or information or reporting configuration associated with the triggering.

Preferably in certain embodiments, the UE receives a message to configure or reconfigure a specific configuration (which is associated with UE-initiated or event triggered reporting). Preferably in certain embodiments, receiving the message would have a status change which is a configuration or reconfiguration for a specific configuration (associated with UE-initiated or event triggered reporting). Preferably in certain embodiments, the status change means that the UE from a first specific configuration (original used, if any) to a second specific configuration based on or due to receiving the message. Preferably in certain embodiments, for triggering one or more reportings due to or in response to receiving the message, the status change does not include or comprise a case that the message removes the first specific configuration without replacing a second specific configuration (or the message disable functionality of the first specific configuration without configuring a replaced second specific configuration). Preferably in certain embodiments, in response to the message at least NOT disabling functionality for UE-initiated or event triggered reporting, the UE triggers one or more reportings. Preferably in certain embodiments, once the message is to at least disable functionality for UE-initiated or event triggered reporting, the UE does not trigger one or more reportings. Preferably in certain embodiments, the message is per UE (e.g., all serving cells is shared same message). Preferably in certain embodiments, the message could comprise information related to which set of serving cells having or associated or linking to the specific configuration in the message. Preferably in certain embodiments, the message is per cell group (e.g., serving cell(s) in MCG and serving cell(s) in SCG corresponds to a different message). Preferably in certain embodiments, per a CG's message could have or provide or indicate an independent set of serving cell(s) in a corresponding cell group which serving cell having or associated or linking to the specific configuration in the message. Preferably in certain embodiments, the message could be per serving cell. Preferably in certain embodiments, based on whether the message to enable or indicate or configure or reconfigure the functionality of UE-initiated or event-triggered reporting or the specific configuration (associated with UE-initiated or event triggered reporting), the UE could determine whether to trigger one or more reportings and/or attempt to transmit the one or more reportings. Preferably in certain embodiments, once the message is to disable functionality of UE-initiated or event triggered reporting, the UE does not trigger one or more reportings. Preferably in certain embodiments, in response to the message (or in response to the message configuring or reconfiguring the specific configuration), the UE triggers the one or more (UE-initiated or event triggered) reportings. Preferably in certain embodiments, in response to the triggering, the UE would attempt to transmit the one or more triggered (UE-initiated or event triggered) reportings. Preferably in certain embodiments, the message is associated with or for configuring UE-initiated or event triggered reporting associated with a serving cell. Preferably in certain embodiments, the message is to configure UE-initiated or event triggered reporting to include or comprise a serving cell. Preferably in certain embodiments, the UE receives the message along with servingcellconfig or servingcellconfigcommon.

Preferably in certain embodiments, the UE receives the message which is one or belonging to or included in servingcellconfig or servingcellconfigcommon. Preferably in certain embodiments, the UE receives the message which is associated with one of CSI-reporting configuration (for UE-initiated or event triggered reporting). Preferably in certain embodiments, the UE receives the message which is associated with a measurement configuration which is associated with UE-initiated or event triggered reporting. Preferably in certain embodiments, the one or more triggered (UE-initiated or event triggered) reportings are associated with at least a serving cell (or the one or more triggered (UE-initiated or event triggered) reportings comprise reporting of at least the serving cell). Alternatively in certain embodiments, the one or more triggered (UE-initiated or event triggered) reportings are associated with a cell group (e.g., MCG or SCG) comprising the serving cell. Alternatively in certain embodiments, the one or more triggered (UE-initiated or event triggered) reportings are associated with all configured serving cell groups comprising the serving cell. Preferably in certain embodiments, the one or more triggered (UE-initiated or event triggered) reportings are (triggered) in response to at least those serving cells (comprising the serving cell) which the UE has received the message or the message includes or comprises a specific configuration (associated with UE-initiated or event triggered reporting). Preferably in certain embodiments, the one or more triggered (UE-initiated or event triggered) reportings are without (or do not comprise or include) reporting associated with non-impacted serving cell(s) which is without status change or without receiving a message for configuring or reconfiguring the specific configuration. Preferably in certain embodiments, the one or more triggered (UE-initiated or event triggered) reportings are without (or do not comprise or include) reporting associated with non-impacted serving cell(s) which is NOT included or comprises or indicated by the message with the specific configuration. Preferably in certain embodiments, in some examples, the UE communicates with a first serving cell and a second serving cell. Preferably in certain embodiments, three possible scenarios could be that both are configured with the specific configuration, the first serving cell is configured with the specific configuration while the second serving cell is NOT configured with the specific configuration, or both are not configured with the specific configuration. Preferably in certain embodiments, in this example, the first serving cell is configured with the specific configuration while the second serving cell is NOT configured with the specific configuration, once the UE receives a message to configure or reconfigure the second serving cell of the specific configuration, the UE triggers one or more (UE-initiated or event triggered) reportings associated with at least the second serving cell and/or attempts to transmit the one or more reportings. Preferably in certain embodiments, for a similar example, when the UE receives a second message to reconfigure the specific configuration (e.g., adjust/add/remove one or more parameters or configurations or information elements in the previous configuration) which is associated with the first serving cell, the UE triggers one or more (UE-initiated or event triggered) reportings associated with at least the second serving cell and/or attempts to transmit the one or more reportings. Preferably in certain embodiments, note that when the message indicates removing or adjusting one or more parameters of configurations or information elements in the previous configuration, the UE triggers one or more reportings (in response to or due to the message) at least when the message is still or keeps the functionality of the UE-initiated or event triggered reportings (no matter whether the message is per UE, per CG, or per serving cell). Preferably in certain embodiments, for another/other example, the message or another type of message (which is in addition to the message) could comprise one or more serving cells where to have or configure with UE-initiated or event triggered reporting. Preferably in certain embodiments, when/once the UE receives the message having a different set of one or more serving cells having or configuring with UE-initiated or event triggered reporting, the UE triggers one or more reportings and/or attempts to transmit the one or more reportings. Preferably in certain embodiments, the UE triggers the one or more reportings (only) when receiving configuration or reconfiguration of the specific configuration (associated with UE-initiated reporting). Preferably in certain embodiments, other criteria could be that when a third serving cell with or having the specific configuration and the UE detects an event (associated with the third serving cell) is satisfied for triggering, this triggers one or more reportings. Preferably in certain embodiments, when the UE triggers one or more reportings, the one or more reportings comprise reporting associated with at least impacted serving cell(s). Preferably in certain embodiments, the one or more triggered (UE-initiated or event triggered) reportings are without reporting associated with a cell without having or receiving the message for configuring or reconfiguring the specific configuration (associated with UE-initiated or event triggered reporting).

For example, each event triggering or the above specified triggering corresponds to each one or more reportings. Preferably in certain embodiments, a first one or more reportings could be triggered in response to receiving a message for configuration or reconfiguration of the specific configuration (associated with UE-initiated or event triggered reporting) for a first serving cell or associated with the first serving cell. Preferably in certain embodiments, a second one or more reportings could be triggered in response to the (already configured/specified) event or condition is met for a second serving cell or associated with the second serving cell. Preferably in certain embodiments, the (already configured/specified) event or condition could be that a set of RSs with a measurement result being lower than a threshold. Preferably in certain embodiments, the measurement result could be applied with a long term average (e.g., L3-filter) or without a long term average.

Preferably in certain embodiments, the (already configured/specified) event or condition is associated with a specific configuration associated with the second serving cell.

Preferably in certain embodiments, a status change for triggering one or more (UE-initiated or event triggered) reportings could comprise an event or triggering cause as the UE is from a Small Data Transmission (SDT) to non-SDT. More specifically, when the UE switches from a (Radio Resource Control (RRC)) inactive state to a (RRC) connected state, the UE would trigger the one or more reportings. Preferably in certain embodiments, in response to receiving a message to indicate change from SDT to non-SDT, the UE would trigger the one or more reportings. Preferably in certain embodiments, the UE would use a CG SDT resource comprising the one or more reportings to a network node.

Preferably in certain embodiments, a status change for triggering one or more (UE-initiated or event triggered) reportings could comprise an event or triggering cause that the UE receives an RRC resume message (or a message associated with or indicating RRC resume). More specifically, when the UE enters to an RRC connected state (due to the RRC resume message) or the UE receives the message associated with or indicating RRC resume, the UE would trigger the one or more reportings.

Preferably in certain embodiments, throughout the present disclosure, state change could be interchangeable with status change.

Preferably in certain embodiments, the UE does not trigger one or more reportings due to status change between NES active time and NES non-active time.

Preferably in certain embodiments, the UE does not trigger one or more reportings due to status change from a beam failure triggering to a beam failure reporting.

Preferably in certain embodiments, the UE does not trigger one or more reportings due to one or more particular state changes.

Preferably in certain embodiments, due to the one or more triggered (UE-initiated or event triggered) reportings being associated with or measured for DL channel quality (e.g., UE-initiated CJT calibration reporting or UE-initiated beam reporting), the one or more triggered (UE-initiated or event triggered) reportings comprise reporting information of serving cell(s) with DL operation.

Preferably in certain embodiments, in response to the triggered one or more (UE-initiated or event triggered) reportings, when there is no UL resource (available for transmission) accommodating the one or more reportings, the UE would trigger an SR (which is associated with one or more UE-initiated or event triggered reporting). Preferably in certain embodiments, the UE would trigger any (allowed) SR for requesting a UL resource for transmitting the one or more reportings. Preferably in certain embodiments, the UL resource should be for a new Transport Block (TB) or MAC Protocol Data Unit (PDU) UL transmission. Alternatively in certain embodiments, the UE may not trigger an SR in response to the triggered one or more reportings.

Preferably in certain embodiments, the UE could be configured with an SR for one or more (UE-initiated or event triggered) reportings. Preferably in certain embodiments, an SR configuration for the one or more reportings is not configured or associated with a Physical Random Access Channel (PRACH). Preferably in certain embodiments, when the UE cancels SR triggered by triggered one or more reportings, the UE does not or without transmitting PRACH (or initiating/triggering RACH procedure) due to the cancelled SR.

Preferably in certain embodiments, one middle group solution is to have a configuration to control or configure whether the UE is to transmit PRACH (or initiate/trigger RACH procedure).

Preferably in certain embodiments, the UE prevents or does not trigger UE-initiated reporting for a serving cell which is in a dormant BWP or which is not an activated serving cell.

Preferably in certain embodiments, a triggering cause may be applied (by the UE) for or associated with a serving cell which is not in a dormant BWP or which is a serving cell.

Preferably in certain embodiments, a triggering cause will not meet for a serving cell when the serving cell is in a dormant BWP or which is not an activated serving cell.

Preferably in certain embodiments, even if the UE triggers (and transmits) reporting associated with a plurality of serving cell(s) (e.g., per CG triggering/transmitting), the reporting information is not associated with a serving cell(s) which is in a dormant BWP or which is not an activated cell.

Preferably in certain embodiments, no matter whether a plurality of serving cell(s) comprise a serving cell(s) which is in a dormant BWP or which is not an activated cell or not, once the UE triggers reporting associated with the plurality of serving cell(s) (e.g., per CG triggering/transmitting), the reporting information could associate with the serving cell(s) (e.g., all serving cell(s) in the plurality of serving cell(s)).

Preferably in certain embodiments, different triggering cause (for UE-initiated or event triggered) reporting is limited or restricted to be multiplexed in one timing or one PUCCH/PUSCH/UL resource.

Preferably in certain embodiments, the UE should transmit the first one or more reportings on a first PUCCH/PUSCH/UL resource. Preferably the UE should transmit the second one or more reportings on a second PUCCH/PUSCH/UL resource. Preferably in certain embodiments, the second PUCCH/PUSCH/UL resource and the first PUCCH/PUSCH/UL resource are in a different slot or a different TTI or a different subframe or a different sub-slot or a different symbol (even in a same slot). Preferably in certain embodiments, the first PUCCH/PUSCH/UL resource are a scheduled/configured resource. Preferably in certain embodiments, the second PUCCH/PUSCH/UL resource are a scheduled/configured resource. Preferably in certain embodiments, the first PUCCH/PUSCH/UL resources are associated with or in a first serving cell.

Preferably in certain embodiments, the second PUCCH/PUSCH/UL resources are associated with or in a second serving cell. Preferably in certain embodiments, the UE determines which cell comprising PUCCH/PUSCH/UL resource to comprise one or more resources based on the one or more reporting is associated with or a triggered cause is associated with which serving cell. In this example, for the first one or more reportings associated with the first serving cell (or due to the first one or more reportings being triggered for or associated with the first serving cell), the UE transmits the first one or more reportings on the first PUCCH/PUSCH/UL resource on the first serving cell. In a similar example, for a second one or more reportings associated with the second serving cell, or due to the second one or more reporting being triggered for or associated with the second serving cell), the UE transmits the second one or more reportings on the second PUCCH/PUSCH/UL resource on the second serving cell. Preferably in certain embodiments, in one example, the first serving cell is the same as the second serving cell. Preferably in certain embodiments, in some examples, a specific configuration could indicate or configure one or more PUCCH/PUSCH/UL resources on a serving cell (e.g., the first serving cell or the second serving cell). Preferably in certain embodiments, based on triggering cause being due to or associated with which specific configuration, the UE applies or uses the indicated/configured one or more PUCCH/PUSCH/UL resources on the serving cell.

Preferably in certain embodiments, in some examples, a different triggering cause may have the same priority for multiplexing in one UL resource. Preferably in certain embodiments, in another/other example, a different triggering cause may have a different priority for multiplexing in one UL resource. Preferably in certain embodiments, based on an ID of a specific configuration or ID of a serving cell associated with a specific configuration or a measurement RS of a serving cell associated with a specific configuration or a different triggering cause, priority for one or more reportings due to different triggering causes could be determined. In one example, triggering causes such as status change could have a higher priority than a condition/event met (e.g., measurement result lower than a threshold or a number of events that the measurement results being lower than a threshold exceeds a number threshold). Alternatively in certain embodiments, a triggering cause such as a status change could have a lower priority than a condition/event met (e.g., measurement result lower than a threshold or a number of events that a measurement result being lower than a threshold exceeds a number threshold). Preferably in certain embodiments, when or if a UL resource can accommodate a first one or more reportings and a second one or more reportings due to different triggering cause, the UE could multiplex both the first one or more reportings and the second one or more reportings. Preferably in certain embodiments, when or if a UL resource cannot accommodate a first one or more reportings and a second one or more reportings due to a different triggering cause, the UE could prioritize to multiplex a higher priority one. Preferably in certain embodiments, triggering timing could be a further criteria for determining priority.

Preferably in certain embodiments, in one example, earlier triggering could have higher priority than latter triggering. Alternatively in certain embodiments, latter triggering could have higher priority than earlier triggering. Preferably in certain embodiments, the first serving cell is different than the second serving cell.

Preferably in certain embodiments, the first PUCCH/PUSCH/UL resource is not overlapped with the second PUCCH/PUSCH/UL resource in time domain. Alternatively in certain embodiments, the first PUCCH/PUSCH/UL resource could be at least partially overlapped with the second PUCCH/PUSCH/UL resource in time domain. Alternatively in certain embodiments, different triggering cause (for UE-initiated or event triggered) reporting could be multiplexed in one timing or one PUCCH/PUSCH/UL resource. Preferably in certain embodiments, for a given serving cell, the UE does not expect or does not trigger or is limited to trigger more than one reporting due to the same triggering cause (until the UE cancels the previous triggering or until a timer expires or before a timing). Preferably in certain embodiments, for example, when the UE triggers a reporting due to a specific configuration associated with the first serving cell, the UE does not expect or does not trigger or is limited to trigger another reporting (due to the same specific configuration) (until the UE cancels the previous triggering or until a timer expires or before a timing). Preferably in certain embodiments, for a given serving cell, the UE does not expect or does not trigger or is limited to trigger more than one reporting due to a different triggering cause. Preferably in certain embodiments, for example, when the UE triggers a reporting due to a status change associated with the first serving cell, the UE does not expect or does not trigger or is limited to trigger another reporting (due to a specific configuration associated with the first serving cell) (until the UE cancels the previous triggering or until a timer expires or before a timing).

Preferably in certain embodiments, based on the timer or the timing is per triggering cause or per serving cell, the UE could determine whether to be allowed to trigger another later reporting (due to same or another specific configuration).

Additionally and/or alternatively in certain embodiments, a UE could (only) transmit one (single) (set of) the one or more reportings to indicate information (status) up to (and including) the last event/condition that triggered a reporting prior to assembly or transmission of the one or more reportings. For example, (only) one (set of the one or more) reporting could be included in a MAC PDU.

Preferably in certain embodiments, once or when the UE triggers one or more reportings, the UE starts a timer or determines a timing. Preferably in certain embodiments, the timer or the timing is to control or determine whether to cancel the triggering. Preferably in certain embodiments, triggering or timer or timing is any one or any combination of per specific configuration (associated with UE-initiated or event triggered reporting), per serving cell, per serving cell group, or per triggering cause. Preferably in certain embodiments, before the timer expires or the timing, the UE is limited to trigger another reporting due to different granularity of UE-initiated or event triggered reporting. In one example, if the timer or timing is per triggering cause, then the UE could trigger for a same serving cell in a different timing with a different triggering cause (before the timing and/or the timer expires). In another example, if the timer or timing is per serving cell, the UE is limited to trigger another reporting for a same serving cell in a different timing with a different triggering cause (before the timing and/or the timer expires). Preferably in certain embodiments, the timing and/or the timer corresponds to a latency requirement associated with the triggering cause or the UE-initiated or event triggered reporting. Preferably in certain embodiments, each/one specific configuration (associated with UE-initiated or event triggered reporting) could comprise or configure an individual latency requirement.

Preferably in certain embodiments, based on the UE's location (far or near to network node), the UE could apply a different specific configuration associated with the same serving cell. Preferably in certain embodiments, a different specific configuration (associated with same serving cell) may have a different triggering cause or a different triggered event. In one example, a first specific configuration could be configured with a first number of times as a satisfying condition to trigger the UE-initiated or event triggered reporting while a second specific configuration could be configured with a second number of times as a satisfying condition to trigger the UE-initiated or event triggered reporting. Preferably in certain embodiments, more than one specific configuration associated with the same serving cell may have a different triggering cause or a different triggered event. Preferably in certain embodiments, a different specific configuration (associated with the UE-initiated or event triggered reporting) could have a same (or limited to be configured with same) latency requirement.

Preferably in certain embodiments, the UE resets the timer or stops the timer when the UE transmits the triggered reporting. For example, when the UE transmits the first one or more triggered reportings, the UE stops or resets the timer associated with the first one or more triggered reportings.

Preferably in order to prevent frequently triggering, the UE could be configured with a prohibit timer associated with the UE-initiated or event triggered reporting. Preferably in certain embodiments, granularity for a prohibit timer could be any one of or any combination of per UE or per serving cell or per serving cell group or per specific configuration (associated with the UE initiated or event triggered reporting) or per triggering cause. Preferably in certain embodiments, the UE starts the prohibit timer when or in response to the UE transmitting the UE-initiated or event triggered reporting. Preferably in certain embodiments, one criteria needed to meet for triggering one or more (UE-initiated or event triggered) reportings is based on the prohibit timer expiring. Preferably in certain embodiments, in other words, once a condition of a first triggering cause is met (associated with one specific configuration), the UE would not trigger reporting due to a corresponding prohibit timer is not expired. Preferably in certain embodiments, if the prohibit timer is configured or present or applied, at least when the prohibit timer expires or is not running, the UE could trigger (UE-initiated or event triggered) reporting. Preferably in certain embodiments, (only) when the prohibit timer expires or has expired, could the UE trigger one or more reportings (e.g., a periodic reporting). Preferably in certain embodiments, a prohibit timer (associated with UE-initiated or event triggered reporting) could be one triggering cause for one or more reportings. For example, the UE could trigger (periodic) reportings in response to expiry of the prohibit timer. Alternatively in certain embodiments, the UE could trigger (periodic) reporting in response to expiry of a periodic timer (different from the prohibit timer). Preferably in certain embodiments, power backoff (e.g., Power management Maximum Power Reduction (P-MPRC)) due to power management could be one triggering cause for one or more (UE-initiated or event triggered) reportings.

Preferably in certain embodiments, a better measurement result could be replaced by (i) a measurement result due to or associated with an indicated beam or TCI state is with an amount worse than a measurement result due to or associated with one candidate beam or candidate TCI state (e.g., quality or measurement result of one candidate beam or candidate TCI state is a threshold value (or an offset) better than a quality or measurement result of the indicated beam or TCI state), or (ii) a measurement result due to or associated with an indicated beam or TCI state is worse than an amount threshold (e.g., quality or measurement result of the indicated beam or TCI state is a threshold value (or an offset) worse than a threshold value), or (iii) a measurement result due to or associated with one candidate beam or candidate TCI state is better than a second amount threshold, or (iv) a measurement result due to or associated with an indicated beam or TCI state is worse than an amount threshold and measurement result due to or associated with one candidate beam or candidate TCI state is better than a second amount threshold. Preferably in certain embodiments, for a first serving cell with above (i) or (ii), or (iii) or (iv) being satisfied, one or more triggered reportings comprise one or more candidate beams related information associated with the first serving cell.

Preferably in certain embodiments, for a second serving without above (i) or (ii), or (iii) or (iv) being satisfied, the one or more triggered reportings comprise without one or more candidate beams related information associated with the second serving cell. Preferably in certain embodiments, both the first serving cell and the second serving cell are configured or associated with a same serving cell group. Preferably in certain embodiments, a measurement result could correspond to a long term average measurement result. Preferably in certain embodiments, long term may mean there is more than one measurement result associated with more than one measurement opportunity.

Throughout the present disclosure, triggering cause (for the UE-initiated or event triggered) reporting could correspond to any of the above triggering.

Throughout the present disclosure, different triggering cause (for UE-initiated or event triggered) reporting could correspond to any of the above triggering and/or corresponding to a different event/condition or a different specific configuration (associated with the UE-initiated or event triggered reporting).

Throughout the present disclosure, triggering cause could correspond to an event/condition or the above specified triggering case (e.g., status change).

Throughout the present disclosure, “state change” could be interchangeable with “state transition”.

Preferably in certain embodiments, a number of the one or more triggered (UE-initiated or event triggered) reportings is determined based on at least which serving cell(s) or those serving cell(s) configured with UE-initiated or event triggered reporting.

Preferably in certain embodiments, the UE could be configured with a maximum number of triggered (UE-initiated or event triggered) reportings. Preferably in certain embodiments, when the UE is configured with L serving cell(s) with one or more triggered (UE-initiated or event triggered) reportings, the number of the one or more triggered reportings comprise reporting information associated with at most the L serving cell(s). Preferably in certain embodiments, each of the L serving cell(s) could be configured with one or more specific configurations or events or triggering causes. Preferably in certain embodiments, a number of specific configurations could be configured independently per cell among L serving cell(s). Preferably in certain embodiments, a number of specific configurations could be configured or shared among L serving cell(s) (e.g., the number of specific configurations is the same among the L serving cell(s)). Preferably in certain embodiments, each of the L serving cell(s) could be specified one or more triggering causes. Preferably in certain embodiments, based on a number of the specified or configured numbers of triggering causes, one or each of the L serving cell(s) corresponds to up to M triggering reporting information.

Preferably in certain embodiments, the UE has a capability to maintain or control to trigger (and not cancelled) a number of the one or more triggered (UE-initiated or event triggered) reportings. Preferably in certain embodiments, the UE has a capability to maintain or control to maintain a number of one or more triggered reportings among serving cell(s) configured with specific configuration(s) or among serving cell(s) associated with the UE-initiated or event triggered reporting or among all serving cell(s). Preferably in certain embodiments, the UE has a (second) capability to maintain or control to maintain a number of one or more triggered reportings per serving cell or per serving cell associated with the UE-initiated or event triggered reporting. Preferably in certain embodiments, the UE has a capability to maintain or control to maintain a number of one or more triggered reportings. Preferably in certain embodiments, once the UE has a first number of triggered reporting (which is pending and not cancelled) and once an event or triggering cause is satisfied (e.g., there are a number of measurement results, associated with a candidate beam or candidate RS, being with better than a measurement result associated with an indicated beam), the UE does not or without triggering the UE-initiated reporting. Preferably in certain embodiments, in this case, the UE would delay the UE-initiated triggering. Preferably in certain embodiments, the UE would store the counter or timer associated with the UE-initiated or event triggering reporting or store counter timer associated with the triggering cause or event (e.g., depends on the granularity of the counter or timer is configured or is per which target). Preferably in certain embodiments, a second capability regarding a number of simultaneous pending (triggered and not cancelled) reportings per cell and a first capability regarding a number of simultaneous pending (triggered and not cancelled) reportings per UE are reported by a UE to a network node. Preferably in certain embodiments, when the UE reports either of the first capability or the second capability, there may be a default number or value to determine a non-reported one. For example, when the UE does not report the first capability, the capability reporting implies or indicates the UE does not support the UE-initiated reporting.

Alternatively in certain embodiments, when the UE does not report the second capability, the capability reporting implies or indicates per cell the UE only supports a number of triggering reportings. Preferably in certain embodiments, once the UE supports the first capability, the UE shall report the second capability (simultaneously).

Preferably in certain embodiments, a number of the one or more triggered (UE-initiated or event triggered) reportings are determined based on at least which serving cell(s) is configured with the UE-initiated or event triggered reporting.

Preferably in certain embodiments, the serving cell is configured with the UE-initiated or event triggered reporting. Preferably in certain embodiments, the UE receives a configuration from a network node for configuring the UE-initiated or event triggered reporting associated with the serving cell. Preferably in certain embodiments, the UE-initiated or event triggered reporting is configured in a specific configuration.

Preferably in certain embodiments, the specific configuration cannot be or limited to be NOT configured in an aperiodic CSI triggering state (e.g., the rationale is to have an independent mechanism between the UE trigger and the network node trigger). Preferably in certain embodiments, the specific configuration is dedicated for UE triggered reporting. Preferably in certain embodiments, the network node is limited to NOT trigger the UE to apply or use the specific configuration to report one or more second reportings in response to a DCI.

Preferably in certain embodiments, the DCI schedules UL resource(s) for transmission comprising the one or more second reportings. Preferably in certain embodiments, the one or more second reportings are multiplexed in the UL resource(s). Preferably in certain embodiments, the one or more second reportings are configured in a one or more configurations (e.g., one or more CSI-reporting configurations) which is different than the specific configuration. Preferably in certain embodiments, the specific configuration could correspond to a CSI-reporting configuration. Preferably in certain embodiments, one parameter in a CSI-reporting configuration could be used to indicate the CSI-reporting configuration is associated with either the UE trigger or the network node trigger. Based on the one parameter, the UE could determine whether one CSI reporting configuration corresponds to the UE triggered or network node triggered reporting. Preferably in certain embodiments, the one parameter in CSI-reporting configuration could correspond to a legacy parameter (or a new parameter) with a new code-point or a new value for indicating time domain behavior. For example, the one parameter in a CSI-reporting configuration could be CSI-AperiodicTriggerStateList. The one parameter could be a (non-zero) codepoint of a CSI request field indicated in DCI. In one example, the one parameter could indicate {aperiodic, periodic, semi-persistent, UE triggered}. Preferably in certain embodiments, based on the one parameter or indication from the one parameter, the UE could determine time domain behavior associated with one CSI reporting configuration. Preferably in certain embodiments, the UE does not expect to be configured with an aperiodic CSI triggering state which is associated with CSI reporting configuration which is configured with or associated with UE triggering. Preferably in certain embodiments, the UE would measure or receive one or more RSs associated with one or more CSI reporting configurations which is configured with UE triggering. Preferably in certain embodiments, for UE triggered reporting, the UE measures one or more RSs associated with one or more CSI reporting configurations which is configured with UE triggering. Preferably in certain embodiments, the one or more RSs (for deriving CSI associated with UE triggered reporting) could be also associated with a CSI reporting configuration which is configured other than UE triggering. Alternatively in certain embodiments, the one or more RSs are limited to be also associated with a CSI reporting configuration which is configured with UE triggering.

Preferably in certain embodiments, a network node triggered reporting comprises or corresponds to aperiodic CSI-reporting, periodic CSI-reporting, semi-persistent CSI-reporting.

Preferably in certain embodiments, a UL resource for transmitting one or more triggered reportings (e.g. UE triggered reporting) could be based on a semi-static configured resource or dynamic scheduling.

Preferably in certain embodiments, a semi-static configured resource corresponds to a resource associated with type-1 or a resource associated with a type-2 UL configured grant. Preferably in certain embodiments, a dynamic resource corresponds to a resource scheduled by a third DCI. Preferably in certain embodiments, the third DCI is not allowed to trigger aperiodic CSI-reporting. Alternatively in certain embodiments, the third DCI is not allowed to trigger aperiodic CSI-reporting. Preferably in certain embodiments, the third DCI is received after the timing of the transmitting request for at least the UE triggered reporting.

Preferably in certain embodiments, one restriction is applied in a network node for a DCI scheduling UL resource.

Preferably in certain embodiments, in response to the triggering, the UE would report the one or more (triggered) reportings to a network node. Preferably in certain embodiments, resource for (delivering/comprising/transmitting) the one or more triggered reportings could be (pre-)configured by the network previously, if (pre-)configured. Preferably in certain embodiments, a resource corresponds to a PUCCH or PUSCH resource. Preferably in certain embodiments, when there are no such resources accommodating the (triggered) one or more reportings, the UE would trigger a specific SR (for requesting resource). Preferably in certain embodiments, the specific SR is (pre-)configured with the purpose for requesting resources for transmitting (triggered) one or more reportings. Preferably in certain embodiments, the triggering one or more reportings is triggered by the UE (itself). Preferably in certain embodiments, the triggered one or more reportings are based on at least one or more network node's signalling indicating status change. Preferably in certain embodiments, the specific SR is not associated with a logical channel.

Alternatively in certain embodiments, the specific SR could be configured or associated with a logical channel. Preferably in certain embodiments, the specific SR could be triggered without being associated with a Buffer Status Reporting/Report (BSR). Preferably in certain embodiments, the specific SR is not associated with a RACH configuration.

Preferably in certain embodiments, the one or more conditions may have a relative short period than an event associated with mobility.

Preferably in certain embodiments, after transmitting the specific SR, the UE (expects to) receive a fourth DCI for scheduling a UL resource for delivering/transmitting one or more triggered reportings.

Preferably in certain embodiments, before transmitting the specific SR or before triggering one or more reportings, the UE does not expect to receive a fourth DCI for scheduling a UL resource for delivering/transmitting one or more triggered reportings. Preferably in certain embodiments, the fourth DCI is one kind of the third DCI. Preferably in certain embodiments, the fourth DCI schedules a PUCCH or PUSCH resource for the one or more UE triggered reportings. In an example, after the UE transmitting the specific SR (and one or more triggered reportings are not cancelled and/or the triggered scheduling request is not cancelled), a UL resource (scheduled by the third DCI or the fourth DCI) could correspond to PUCCH or PUSCH. The fourth DCI could indicate a parameter (e.g., a (non-zero) codepoint in a CSI request field) associated with the (triggered) one or more reportings. The UE may not deliver/transmit the one or more triggered reportings on a UL resource scheduled by a DCI if or when the DCI does not indicate the parameter associated with the one or more triggered reportings. For a specific PUCCH scheduled by the fourth DCI, the fourth DCI could be a standalone DCI without a scheduling DL (e.g., PDSCH) or UL (e.g., PUSCH).

Preferably in certain embodiments, the specific PUCCH is merely to comprise the one or more triggered reportings. Preferably in certain embodiments, the specific PUCCH could be (further) determined based on a payload size of the one or more triggered reportings. For example, a different payload size could correspond to a different specific PUCCH. Preferably in certain embodiments, the UE could be configured with a set of specific PUCCH resources. Preferably in certain embodiments, a first specific PUCCH resource (with lowest PUCCH resource ID or lowest ID in the set of PUCCH resources) in the set of PUCCH resources is determined to use (in response to the fourth DCI), when a payload size corresponds to a first range (e.g., 1˜a first number−1). Preferably in certain embodiments, a second specific PUCCH resource (with second lowest PUCCH resource ID or second lowest ID in the set of PUCCH resources) in the set of PUCCH resources is determined to use (in response to the fourth DCI), when a payload size corresponds to a second range (e.g., the first number˜a second number−1). In other words, since the network node does not know which one or which set of reporting configurations (associated with UE triggered) is triggered, one fourth DCI could correspond to a set of specific PUCCH resources. Preferably in certain embodiments, the UE could be configured with one or more payload size ranges associated with one specific PUCCH resource in the set of specific PUCCH resources. Preferably in certain embodiments, the UE could be configured with the first number, the second number, . . . , an N-th number for configuring an N+1's range of payload size. Preferably in certain embodiments, the one or more (triggered) reportings correspond to CSI reporting. Preferably in certain embodiments, the one or more (triggered) reportings do not correspond to Hybrid Automatic Repeat Request (HARQ) reporting. Preferably in certain embodiments, the one or more (triggered) reportings do not correspond to a CSI reporting configuration which is NOT associated with the UE triggered.

When there is overlapping between UE triggered reporting and UCI or network node triggered reporting, or when the UE triggered reporting and UCI or network node triggered reporting are (attempted to be transmitted) in a same TTI (e.g., subslot, a number of symbols, slot, subframe) which may be in a different symbol (without being overlapped), the UE prioritizes UE triggered reporting. Alternatively in certain embodiments, the UE prioritizes network node triggered reporting.

Preferably in certain embodiments, the prioritization could be performed based on other criteria, the UE could determine to prioritize which triggered reporting. Preferably in certain embodiments, the criteria could be a serving cell index associated with DL RS for measurement used to generate/derive/determine reporting and/or a lower serving cell index corresponds to a higher priority. Preferably in certain embodiments, the UE triggered reporting corresponds to a higher priority than aperiodic CSI reporting. Alternatively and/or preferably in certain embodiments, the UE triggered reporting corresponds to a same priority as aperiodic CSI reporting. Preferably in certain embodiments, the UE triggered reporting corresponds to a higher priority than periodic CSI reporting and/or semi-persistent CSI reporting. Alternatively and/or preferably in certain embodiments, the UE triggered reporting corresponds to a lower priority than periodic CSI reporting and/or semi-persistent CSI reporting. Preferably in certain embodiments, the criteria could be based on an ID of or associated with a reporting configuration, and/or a lower ID corresponds to a higher priority. Preferably in certain embodiments, the criteria could be based on reporting content, and/or reporting content associated with L1-RSRP or L1-SINR could have a higher priority than reporting content associated with non L1-RSRP or non L1-SINR (without CJT calibration reporting). Preferably in certain embodiments, reporting content associated with CJT calibration could be associated with a same priority as reporting content associated with L1-RSRP or L1-SINR. Alternatively and/or preferably in certain embodiments, reporting content associated with CJT calibration could be associated with a higher priority than reporting content associated with L1-RSRP or L1-SINR. Alternatively and/or preferably in certain embodiments, reporting content associated with CJT calibration could be associated with a lower priority than reporting content associated with L1-RSRP or L1-SINR. Preferably in certain embodiments, reporting content associated with CJT calibration could be associated with a higher priority than reporting content associated with non L1-RSRP or non L1-SINR.

Preferably in certain embodiments, prioritization here means or corresponds to be transmitted in a UL resource in the TTI. Preferably in certain embodiments, prioritization here means or corresponds to be multiplexed first/earlier in a UL resource in the TTI. Preferably in certain embodiments, once capacity of the UL resource is achieved, the deprioritized reporting will be dropped or cancelled or not transmitted or not multiplexed in the UL resource in the TTI.

Text proposal 1 could be provided below with underlining and bolding (assuming one or more rejiggered reportings is in form of UCI).

CSI reports are associated with a priority value Pri_{iCSI}(y, k, c, s) = 2 · N_{cells} · Mₛ · y + N_{cells} · Mₛ · k + Mₛ · c + s
where
y = 0 for aperiodic CSI reports to be carried on PUSCH (Alt1) or for UE triggered CSI reporting y = 1 for
semi-persistent CSI reports to be carried on PUSCH, y = 2 for semi-persistent CSI reports to be carried on
PUCCH and y = 3 for periodic CSI reports to be carried on PUCCH;
k = 0 for CSI reports carrying L1-RSRP or L1-SINR (Alt2) or for UE triggered CSI reporting and k = 1
for CSI reports not carrying L1-RSRP or L1-SINR;
c is the serving cell index and N_{cells} is the value of the higher layer parameter maxNrofServingCells;
s is the reportConfigID and Mₛ is the value of the higher layer parameter maxNrofCSI-ReportConfigurations.

Text proposal 2 could be provided below with underlining and bolding (assuming one or more rejiggered reportings is in form of UCI).

CSI reports are associated with a priority value Pri_{iCSI} (y, k, c, s) = 2 · N_{cells} · Mₛ · y + N_{cells} · Mₛ · k + Mₛ · c + s
where
y = 0 for aperiodic CSI reports to be carried on PUSCH y = 1 for semi-persistent CSI reports to be carried on
PUSCH, y = 2 for semi-persistent CSI reports to be carried on PUCCH and y = 3 for periodic CSI reports to
be carried on PUCCH;
k = 0 for CSI reports carrying L1-RSRP or L1-SINR and k = 1 for CSI reports not carrying L1-RSRP or L1-
SINR;
c is the serving cell index and N_{cells} is the value of the higher layer parameter maxNrofServingCells;
s is the reportConfigID and Mₛ is the value of the higher layer parameter maxNrofCSI-ReportConfigurations.
(Alt1)PriiCSI associated with UE triggered reporting is associated with higher priority(lower value)than PriiCSI
associated with aperiodic, periodic, semi-persistent CSI reporting.
(Alt2)PriiCSI associated with UE triggered reporting is associated with lower priority(higher value)than PriiCSI
associated with aperiodic, periodic, semi-persistent CSI reporting.
(Alt3)When one PriiCSI associated with UE triggered reporting is as same as PriiCSIassociated with aperiodic,
periodic, semi-persistent CSI reporting, PriiCSI associated with UE triggered reporting is associated with higher
priority than PriiCSI associated with aperiodic, periodic, semi-persistent CSI reporting.
(Alt4) When one PriiCSI associated with UE triggered reporting is as same as PriiCSIassociated with aperiodic,
periodic, semi-persistent CSI reporting, PriiCSI associated with UE triggered reporting is associated with lower
priority than PriiCSI associated with aperiodic, periodic, semi-persistent CSI reporting.

Preferably in certain embodiments, the UE maintains a counter for counting a number of opportunities that a measurement result of one or more RSs (or one or more RS sets) satisfied for triggering (UE-initiated or event triggered) reporting. Preferably in certain embodiments, once the UE transmits the (UE-initiated or event triggered) reporting, the UE would reset the counter. Preferably in certain embodiments, the UE triggers (UE-initiated or event triggered) reporting when the counter exceeds a threshold. Preferably in certain embodiments, the threshold could be configured per serving cell, per serving cell group, per UE, or per specific configuration (associated with UE-initiated reporting configuration) and/or the counter could be maintained per serving cell, per serving cell group, per UE, or per specific configuration (associated with UE-initiated reporting configuration).

Preferably in certain embodiments, once the UE changes an indicated or activated TCI state, the UE resets the counter associated with UE-initiated or event triggered reporting (which could be resets counting associated with one or more specific configurations associated with the UE-initiated or event triggered reporting). Preferably in certain embodiments, the UE is configured with one or more first specific configurations associated with a first serving cell. Preferably in certain embodiments, the UE is configured with one or more second specific configurations associated with a second serving cell. Preferably in certain embodiments, once the UE changes the indicated TCI state (e.g., by beam indication DCI) or activated TCI state (e.g., by TCI state (de)activation MAC CE), the UE would reset counting of one or more counters associated with the UE-initiated or event triggered reporting. Preferably in certain embodiments, the resetting counting could impact one or more serving cell(s) that the UE performs communication with the indicated or activated TCI state change. Preferably in certain embodiments, the TCI state could be a DL, a UL, and/or a joint TCI state. Preferably in certain embodiments, the TCI state could be a DL or joint TCI state. Preferably in certain embodiments, to reset a counter means or corresponds to set the counter to 0 or an initial value.

Preferably in certain embodiments, once the UE triggers the UE-initiated or event triggered reporting, the UE resets the counter (associated with UE-initiated or event triggered reporting). Preferably in certain embodiments, once the UE cancels the triggered UE-initiated or event triggered reporting, the UE resets the counter. Preferably in certain embodiments, based on granularity of the counter is per which target, the counter associated with target A is reset in response to the triggering associated with target A, and/or the counter associated with target B is not reset in response to the triggered associated with the different target (e.g., target A). Preferably in certain embodiments, the target corresponds to serving cell, serving cell group, specific configuration (associated with UE-initiated or event triggered reporting), the RS associated with one specific configuration (associated with UE-initiated or event triggered reporting), or the RS set associated with one specific configuration (associated with UE-initiated or event triggered reporting).

Preferably in certain embodiments, once the UE performs a MAC reset procedure, the UE resets the counter (associated with UE-initiated or event triggered reporting).

Preferably in certain embodiments, once the UE performs handover or receives a RRCReconfiguration or handover command, the UE resets the counter (associated with UE-initiated or event triggered reporting).

Preferably in certain embodiments, the UE triggers a first UE-initiated reporting when a first triggering cause is satisfied (due to or according to a first specific configuration associated with the UE-initiated or event triggered reporting).

Preferably in certain embodiments, the UE cancels the triggering when a timer expires or after a timing (associated with latency requirement associated with the first specific configuration).

Preferably in certain embodiments, the UE cancels the triggering when the UE transmits the first UE-initiated reporting.

Additionally and/or alternatively in certain embodiments, the UE could cancel all (previous) reporting triggering (including the triggering) that were triggered before assembly or transmission of the first UE-initiated reporting.

Preferably in certain embodiments, the first UE-initiated reporting is determined based on a measurement result of at least a set of RSs.

Preferably in certain embodiments, the UE may receive one or more CSI-reporting configurations associated with network node triggering (which corresponds to one or more second reportings).

Preferably in certain embodiments, the second reporting could associate with another set of RSs.

Preferably in certain embodiments, the another set of RSs could comprise at least one RS as same as at least the set of RSs.

Preferably in certain embodiments, once or when the UE transmits the second reporting (comprising the measurement result based on the least one RS), the UE cancels the triggering. Preferably in certain embodiments, the second reporting is transmitted before the timer expires or before the timing.

Alternatively and/or preferably in certain embodiments, once or when the UE transmits the second reporting (comprising a measurement result based on (one or more or all) RSs associated with the first specific configuration), the UE cancels the triggering. Preferably in certain embodiments, the second reporting is transmitted before the timer expires or before the timing.

Preferably in certain embodiments, one restriction is that the UE does not expect to receive different sets of RSs to be configured for network triggering reporting and UE-initiated reporting. In other words, the CSI-reporting configuration associated with network node triggering is associated with different sets of RSs (without overlapping with RS set associated with the specific configuration associated with UE-initiated or event triggered reporting).

Preferably in certain embodiments, the UE does not expect to receive a configuration such that a specific configuration (associated with UE-initiated, or event triggered reporting) is configured as one aperiodic CSI triggering state (e.g., CSI-AperiodicTriggerState or associatedReportConfigInfoList). Preferably in certain embodiments, except that a CSI reporting configuration having or being configured with time domain behavior being configured as UE-initiated, CSI-reporting configuration could be configured within one aperiodic CSI triggering state.

Alternatively in certain embodiments, configuration of one aperiodic CSI triggering state could associate with a specific configuration having or being configured with time domain behavior as UE-initiated, the UE would consider or determine to interpret the specific configuration as aperiodic CSI-reporting configuration when the UE receives DCI for MAC CE to activate or indicate or trigger the one aperiodic CSI triggering state.

Preferably in certain embodiments, a detecting/measurement RS for or associated with the UE-initiated or event triggered reporting should be configured as periodic. Preferably in certain embodiments, a detecting/measurement RS for or associated with the UE-initiated or event triggered reporting is NOT to be configured as aperiodic. Preferably in certain embodiments, the UE is configured with a detecting/measurement RS in a semi-static way for detecting whether an event is satisfied to trigger.

Preferably in certain embodiments, the UE could receive a specific configuration associated with UE-initiated or event triggered reporting. Preferably in certain embodiments, the specific configuration could correspond to CSI-ReportConfig. Preferably in certain embodiments, the specific configuration could be based on that reportConfigType (e.g., time domain behavior) being as UE-initiated in the CSI-ReportConfig.

The following could be an exemplified structure for CSI-ReportConfig which reportConfigType being configured as UE-initiated (e.g., there is a choice target of UE-initiated in reportConfigType as shown with underline and bold). Preferably in certain embodiments, the UE could receive another/other CSI-ReportConfig which reportConfigType being configured as periodic, semiPersistentOnPUCCH, semiPersistentOnPUSCH, aperiodic.

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, |

sl320},

| | |
|---|---|
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    UE-initiated
    }
  },
```

Preferably in certain embodiments, a detail (or specific) configuration or parameters in reportConfigType being configured as UE-initiated could comprise information associated with any of (one or more) trigger events, (one or more) detecting/measuring RSs, or UL resources. Preferably in certain embodiments, information of a UL resource corresponds to UL resource ID, preferably in certain embodiments, information of trigger event corresponds to a number of thresholds for a claiming event is satisfied. Preferably in certain embodiments, one or more detecting/measuring RSs could be associated with one trigger event. Preferably in certain embodiments, one detecting/measuring RS is one-to-one mapping with the trigger event. Preferably in certain embodiments, another structure could be one trigger event comprising information associated with one or more detecting/measuring RSs. Preferably in certain embodiments, based on an associated one or more detecting/measuring RSs, the UE could have a measurement result associated with detecting/measuring RSs. Preferably in certain embodiments, the specific configuration (e.g., CSI-ReportConfig) could associate with at least two sets of CSI-RSs for detecting/measuring RS. Preferably in certain embodiments, the two sets of CSI-RSs comprise a first set of RSs and a second set of RSs. Preferably in certain embodiments, a measurement result could be applied or determined or measured based on one or more RSs in the first set of RSs. Preferably in certain embodiments, a measurement result could be applied or determined or measured based on one or more RSs in the second set of RSs. Preferably in certain embodiments, using or applying one or both measurement results could be based on a configuration of a trigger event corresponding to (i), (ii), (iii), and/or (iv), as illustrated above. Preferably in certain embodiments, a UL resource could be PUCCH or PUSCH. Preferably in certain embodiments, a configuration or parameter for a UL resource could be absent in a CSI-ReportConfig. Preferably in certain embodiments, based on the specific configuration, the UE could determine or generate one or more (UE-initiated or event triggered) reportings. Preferably in certain embodiments, the one or more (UE-initiated or event triggered) reportings are delivered or comprised in MAC CE or UCI. Preferably in certain embodiments, a quantity associated with the specific configuration corresponds to at least comprising RSRP or SINR.

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, |

sl320},

| | |
|---|---|
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

INTEGER(0..32)

| | |
|---|---|
| UE-initiated | SEQUENCE { |

```
      Trigger event
      (Detecting/measuring RS)
      UL resource
    }
  },
...
```

Preferably in certain embodiments, another example for configuring a first set of RSs and a second set of RSs associated with the specific configuration could be based on an association/mapping configuration. For UE-initiated or event triggered reporting, the UE could receive configuration for configuring association between one specific configuration and a first set of RSs and a second set of RSs. Preferably in certain embodiments, the first or the second set of RSs could be configured based on or indicated by a CSI-RS resource set ID. Preferably in certain embodiments, based on the CSI-RS resource set ID, the UE could determine or identify resourceSet1 corresponding to which RS set for measurement/detecting. Preferably in certain embodiments, based on the CSI-RS resource set ID, the UE could determine or identify resourceSet2 corresponding to which RS set for measurement/detecting. Preferably in certain embodiments, resourceSet1 corresponds to the first set of RSs. Preferably in certain embodiments, resourceSet2 corresponds to the second set of RSs. Preferably in certain embodiments, CSI-ReportConfigId corresponds to a specific configuration (associated with UE-initiated or event triggered reporting).

For example, see below:

| | |
|---|---|
| CSI-AssociatedReportConfigInfo ::= | SEQUENCE { |
| reportConfigId | CSI-ReportConfigId, |
| resourcesForChannel | resourceSet1 |
| resourcesForChannel2 | resourceSet2 |

Preferably in certain embodiments, another example for configuring a set of RSs as a candidate RS (associated with a beam or TCI state for UE-initiated or event triggered reporting) could be based on an association/mapping configuration. For UE-initiated or event triggered reporting, the UE could receive configuration for configuring association between one specific configuration and a set of RSs. Preferably in certain embodiments, the set of RSs could be configured based on or indicated by a CSI-RS resource set ID. Preferably in certain embodiments, based on the CSI-RS resource set ID, the UE could determine or identify resourceSet corresponding to which RS set for measurement/detecting. Preferably in certain embodiments, resourceSet corresponds to the set of RSs. Preferably in certain embodiments, CSI-ReportConfigId corresponds to a specific configuration (associated with UE-initiated or event triggered reporting). Preferably in certain embodiments, one or more RSs associated with an indicated DL/UL/joint TCI state(s) could be determined as or considered as a compared RS. Preferably in certain embodiments, RS(s) configured in the resourceSet shown below could be determined as a candidate beam or candidate RS. Preferably in certain embodiments, RS(s) configured in the resourceSet could be used to trigger reporting. Preferably in certain embodiments, a measurement result according to the RS(s) in the resourceSet could be transmitted as content of the UE-initiated or event triggered reporting.

For example see below:

| | |
|---|---|
| CSI-AssociatedReportConfigInfo ::= | SEQUENCE { |
| reportConfigId | CSI-ReportConfigId, |
| resourcesForChannel | resourceSet |

Various examples and embodiments of the present invention are described below. For the methods, alternatives, concepts, examples, and embodiments detailed above and herein, the following aspects and embodiments are possible.

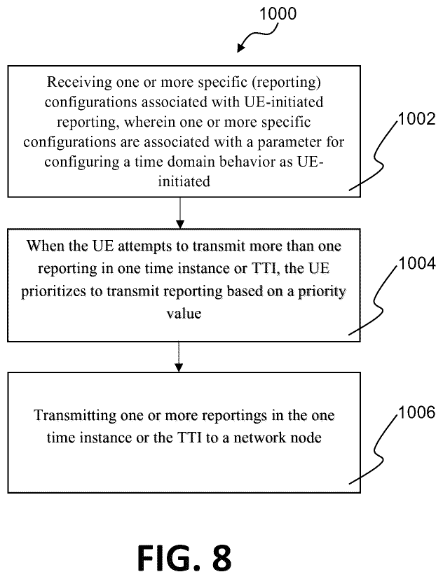

Referring to FIG. 8, with this and other concepts, systems, and methods of the present invention, a method 1000 for a UE (or a network node or a TRP) in a wireless communication system comprises receiving one or more specific (reporting) configurations associated with UE-initiated reporting, wherein one or more specific configurations are associated with a parameter for configuring a time domain behavior as UE-initiated (step 1002), when the UE attempts to transmit more than one reporting in one time instance or TTI, the UE prioritizes to transmit reporting based on a priority value (step 1004), and transmitting one or more reportings in the one time instance or the TTI to a network node (step 1006).

Preferably in certain embodiments, a priority value of reporting is determined based on at least time domain behavior, cell ID, reporting configuration ID, measurement RS ID.

Preferably in certain embodiments, a lower priority value corresponds to a higher priority.

Preferably in certain embodiments, UE-initiated reporting is with higher priority than other reporting associated with a different time domain behavior.

Preferably in certain embodiments, a cell ID corresponds to which cell is configured by or associated with a (specific) reporting configuration for transmitting the reporting.

Preferably in certain embodiments, a cell ID corresponds to which cell is configured by or associated with a (specific) reporting configuration for receiving RS for measurement.

Preferably in certain embodiments, a measurement RS ID corresponds to which RS is configured by or associated with a (specific) reporting configuration for reception for measurement.

Preferably in certain embodiments, a priority value associated with UE-initiated reporting is lower than network triggered reporting.

Preferably in certain embodiments, based on priority, the UE could prioritize to multiplex to transmit reporting which is with ascending order of priority value (e.g., higher priority reporting is multiplexed first) in the time instance or the TTI.

Preferably in certain embodiments, the UE performs multiplexing until the capacity or payload size of the UL resource (for transmitting one or more reporting) in the time instance or the TTI is fulfilled.

Preferably in certain embodiments, the UE could be configured with a first threshold associated with UE-initiated reporting.

Preferably in certain embodiments, the UE could be configured with a second threshold associated with network node triggering reporting.

Preferably in certain embodiments, based on a priority value associated with UE-initiated reporting being smaller than the first threshold and the network node triggering reporting is larger than the second threshold, the UE priorities to multiplex UE-initiated reporting associated with a priority value which is smaller than the first threshold (preferably in certain embodiments, otherwise, the UE prioritizes network node triggered reporting).

Preferably in certain embodiments, based on one threshold, if the priority value associated with UE-initiated reporting is smaller than the first threshold, the UE priorities to multiplex the UE-initiated reporting.

Preferably in certain embodiments, the UE does not expect to multiplex UE-initiated reporting and network node triggered reporting in the same time instance or same TTI.

Preferably in certain embodiments, once the UE multiplexes two kinds of reporting (e.g., UE-initiated reporting and network node triggering reporting), the reporting comprises information associated with a reporting configuration ID or indication related to the UE-initiated reporting or network node reporting.

Preferably in certain embodiments, when the indication related UE-initiated reporting or network node reporting corresponds to 1 or a first value for a first reporting, the first reporting corresponds to UE-initiated reporting (value 1 is an example, which could be value 0).

Preferably in certain embodiments, when the indication related UE-initiated reporting or network node reporting corresponds to 0 or a second value for a second reporting, the second reporting corresponds to network node triggered reporting (value 0 is an example, which could be value 1).

Referring back to FIGS. 3 and 4, in one or more embodiments from the perspective of a UE (or a network node or a TRP) in a wireless communication system, the device 300 includes a program code 312 stored in memory 310 of the transmitter. The CPU 308 could execute program code 312 to: (i) receive one or more specific (reporting) configurations associated with UE-initiated reporting, wherein one or more specific configurations are associated with a parameter for configuring a time domain behavior as UE-initiated; (ii) when the UE attempts to transmit more than one reporting in one time instance or TTI, the UE prioritizes to transmit reporting based on a priority value; and (iii) transmit one or more reportings in the one time instance or the TTI to a network node. Moreover, the CPU 308 can execute the program code 312 to perform all of the described actions, steps, and methods described above, below, or otherwise herein.

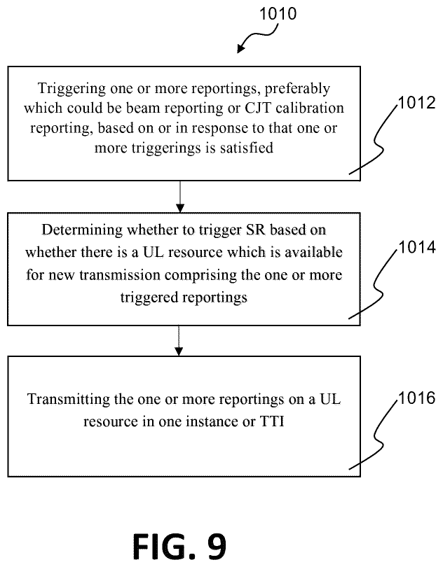

Referring to FIG. 9, with this and other concepts, systems, and methods of the present invention, a method 1010 for a UE (or a network node or a TRP) in a wireless communication system comprises triggering one or more reportings, preferably which could be beam reporting or CJT calibration reporting, based on or in response to that one or more triggerings is satisfied (step 1012), determining whether to trigger SR based on whether there is a UL resource which is available for new transmission comprising the one or more triggered reportings (step 1014), and transmitting the one or more reportings on a UL resource in one instance or TTI (step 1016).

Preferably in certain embodiments, when there is a UL resource available for new transmission comprising the one or more reportings, the UE transmits the one or more reporting without triggering SR.

Preferably in certain embodiments, when there is no UL resource available for new transmission comprising the one or more reportings, the UE triggers SR, and/or transmits SR on a PUCCH resource.

Preferably in certain embodiments, the one or more triggering cause corresponds to status change.

Preferably in certain embodiments, the one or more triggering cause is associated with configured per target.

Preferably in certain embodiments, one target corresponds to any one or any combination of one RS, one RS set, one reporting configuration, one serving cell, one candidate cell, one cell group.

Preferably in certain embodiments, the status change corresponds to any one or any combination of: receiving a signal indicating from a dormant BWP to a non-dormant BWP; a timer expires for changing a dormant BWP to a non-dormant BWP; transmitting a second signal to a network node to change (for requesting from dormant BWP to non-dormant BWP); receiving LTM TCI state activation or indication from a network node; receiving a signal indicating activation of an SCell; receiving a signal indicating activation of a CG; receiving a signal indicating addition of a PSCell (except if the SCG is deactivated), preferably wherein the PSCell is newly added or changed; receiving an RRC reconfiguration message, preferably in certain embodiments, the RRC reconfiguration message is associated with UE-initiated reporting, having change on an RS or serving cell, BWP, or configuration change to UE-initiated reporting; receiving a signal to switch from SDT to non-SDT (or switch from an RRC inactive state to an RRC connected state); receiving an RRC resume message from a network node; detecting a number of pathloss changes being over a value exceeding a threshold; and/or one or more specific configurations for configuring an event related configuration.

Preferably in certain embodiments, there may be one or more further conditions for determining whether the triggering cause is met, and/or the one or more further conditions could be any or any combination of the following: whether a target (e.g., serving cell) associated with one or more reportings is configured with uplink (operation); whether a target (e.g., serving cell) associated with one or more reportings is configured with downlink (operation); and/or preferably in certain embodiments, at least when the above one or both conditions are met, the triggering cause could be considered or determined as met.

Preferably in certain embodiments, there may be one or more further conditions for determining whether the triggering cause is met, and/or the one or more further condition could be any or any combination of following: whether a target (e.g., serving cell) associated with one or more reportings is in an active dormant BWP; whether a target (e.g., serving cell) associated with one or more reportings is NOT activated; whether a prohibit timer associated with a triggering cause is running; whether a prohibit timer associated with one specific configuration is running; preferably in certain embodiments, at least when the above one or all condition are met, the triggering cause could be considered or determined as NOT met; and/or preferably in certain embodiments, at least when the above one or all conditions are met, the UE does not care about whether triggering cause is met or not for the target.

Preferably in certain embodiments, the one or more reportings comprise reporting information associated with at least a triggering cause.

Preferably in certain embodiments, the one or more reportings are without comprising reporting information associated with NO triggered cause and/or triggering cause which associated target is in dormant or NOT activated.

Preferably in certain embodiments, the one or more reportings comprise reporting information associated with both ID information, and a measurement result.

Preferably in certain embodiments, measurement result(s) corresponds to candidate RS(s), or measurement result(s) correspond to both candidate RS(s) and source RS in an indicated TCI state or associated with a currently used/indicated/activated beam/RS.

Preferably in certain embodiments, measurement result corresponds to RSRP or SINR according to RS.

Preferably in certain embodiments, ID information corresponds to either UE-initiated reporting or network node triggering reporting, reporting configuration ID.

Preferably in certain embodiments, the UE starts a prohibit timer once or in response to the UE transmitting one reporting associated with a triggering cause or a specific configuration which is associated with or comprises or configures the prohibit timer.

Preferably in certain embodiments, one or more specific configurations for a configuring event related configuration comprises information with a measurement RS, a measurement quantity.

Preferably in certain embodiments, one or more specific configurations correspond to a CSI-reporting configuration with a flag or parameter for configuring this CSI-reporting configuration corresponds to a UE-initiated reporting configuration.

Preferably in certain embodiments, the flag or the parameter could extend the current RRC parameter for configuring such CSI-reporting configuration's time domain behavior (e.g., aperiodic, periodic, semi-persistent, UE-initiated).

Preferably in certain embodiments, for UE-initiated CSI-reporting configuration, the CSI-reporting configuration is without comprising an RRC configured PUSCH or PUCCH resource associated with the reporting (e.g., PUSCH corresponds to type-1 Uplink (UL) configured grant configuration) and/or preferably, the UE would request or transmit on a current PUCCH or PUSCH available for a new transmission which could accommodate or comprise the UE-initiated reporting associated with the UE-initiated CSI-reporting configuration.

Preferably in certain embodiments, a number of the one or more reportings is determined based on at least or up to a number of triggering causes are met.

Preferably in certain embodiments, based on how many number of triggering causes being met for triggering, how many specific configurations with conditions met for triggering, how many triggering causes associated with one target, one triggering cause being associated with a number of reporting information, the UE could determine a number of the one or more reportings.

Preferably in certain embodiments, one triggering cause may correspond to one or more reporting information.

Preferably in certain embodiments, one target corresponds to one serving cell, one cell group, or one specific configuration associated with UE-initiated reporting.

Preferably in certain embodiments, one reporting information corresponds to a measurement result based on one candidate RS or one pair of candidate RSs or one set of candidate RSs.

Preferably in certain embodiments, one reporting information corresponds to a measurement result based on one pair of one candidate RSs and one currently used/indicated/activated RS.

Preferably in certain embodiments, one reporting information comprises index information associated with a triggering cause (e.g., state change corresponds to index 0, specific configuration corresponds to index 1).

Referring back to FIGS. 3 and 4, in one or more embodiments from the perspective of a UE (or a network node or a TRP) in a wireless communication system, the device 300 includes a program code 312 stored in memory 310 of the transmitter. The CPU 308 could execute program code 312 to: (i) trigger one or more reportings, preferably which could be beam reporting or CJT calibration reporting, based on or in response to that one or more triggerings is satisfied; (ii) determine whether to trigger SR based on whether there is a UL resource which is available for new transmission comprising the one or more triggered reportings; and (iii) transmit the one or more reportings on a UL resource in one instance or TTI. Moreover, the CPU 308 can execute the program code 312 to perform all of the described actions, steps, and methods described above, below, or otherwise herein.

Note that any of the above and herein methods, alternatives, concepts, examples, and embodiments may be combined, in whole or in part, or applied simultaneously or separately.

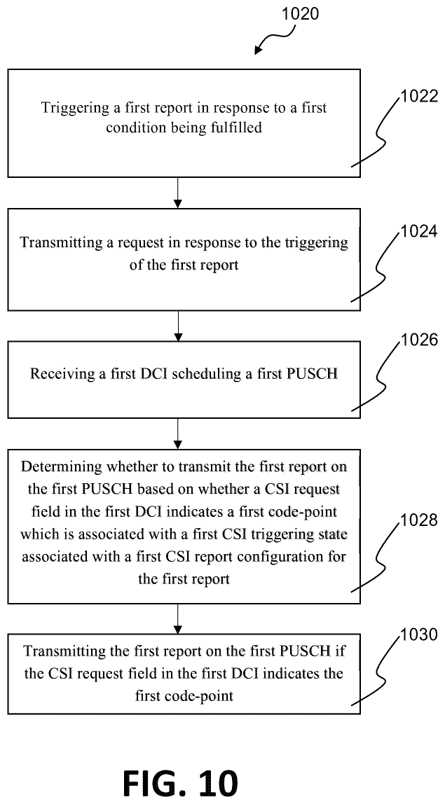

Referring to FIG. 10, with this and other concepts, systems, and methods of the present invention, a method 1020 for a UE in a wireless communication system comprises triggering a first report in response to a first condition being fulfilled (step 1022), transmitting a request in response to the triggering of the first report (step 1024), receiving a first DCI scheduling a first PUSCH (step 1026), determining whether to transmit the first report on the first PUSCH based on whether a CSI request field in the first DCI indicates a first code-point which is associated with a first CSI triggering state associated with a first CSI report configuration for the first report (step 1028), and transmitting the first report on the first PUSCH if the CSI request field in the first DCI indicates the first code-point (step 1030).

In various embodiments, if the CSI request field in the first DCI does not indicate the first code-point, the UE does not transmit the first report on the first PUSCH.

In various embodiments, the request is configured dedicatedly for the first report triggered by the UE, and/or the request is not associated with any logical channel, and/or the request is triggered without being associated with BSR, and/or the request is not associated with a Random Access Channel (RACH) configuration, and/or the request is or corresponds to a SR.

In various embodiments, before transmitting the request, the UE does not expect to receive a DCI with the CSI request field indicating the first code-point, and/or if the UE does not trigger the first report, the UE does not expect to receive the DCI with the CSI request field indicating the first code-point, and/or the first code-point is configured with a single CSI report configuration.

In various embodiments, the UE receives a second configuration for configuring association between the first CSI triggering state and the first CSI report configuration, wherein the first CSI report configuration is associated with the first report triggered by the UE, and/or the second configuration also provides association between a second CSI triggering state and a second CSI report configuration, and/or the second CSI report configuration is for a second report triggered by a network node, and/or based on absence of one parameter associated with the second CSI report configuration, the UE determines that the second CSI report configuration is for a second report triggered by the network node, and/or based on the one parameter indicating information of aperiodic, periodic, or semi-persistent, the UE determines that the second CSI report configuration is for a second report triggered by the network node.

In various embodiments, the UE receives a second DCI scheduling a second PUSCH, and transmits the second report on the second PUSCH in response to the CSI request field in the second DCI indicating a second code-point which is associated with the second CSI triggering state.

In various embodiments, one parameter associated with the first CSI report configuration is used to indicate or configure that the first CSI report configuration is for the first report triggered by the UE, and/or based on presence of the one parameter associated with the first CSI report configuration, the UE determines that the first CSI report configuration is for the first report triggered by the UE, and/or based on the one parameter indicating information of UE-initiated reporting, the UE determines that the first CSI report configuration is for the first report triggered by the UE.

In various embodiments, the UE determines whether the first CSI report configuration is for the first report triggered by the UE based on whether the first CSI report configuration is associated with information associated with an event or a condition and/or based on whether the first CSI report configuration is associated with one or more candidate RSs corresponding to one or more candidate beams, and/or based on the first CSI report configuration is associated with the information associated with the event or the condition and/or based on whether the first CSI report configuration is associated with the one or more candidate RSs corresponding to one or more candidate beams, the UE determines that the first CSI report configuration is for the first report triggered by the UE.

In various embodiments, the UE receives a configuration of the first condition to trigger the first report by the UE, wherein the first report is an L1 report and/or the first report corresponds to one kind of Uplink Control Information (UCI).

In various embodiments, the first condition includes any one of: quality of one or more candidate beams is with an offset better than a quality of a current beam, and the UE determines the quality of the current beam based on measurement of a first RS and determines the quality of the one or more candidate beams based on measurement of one or more candidate RSs, and the quality corresponds to L1-RSRP.

In various embodiments, if the UE receives a type-1 UL configured grant configuration for a set of UL resources for transmitting the first report triggered by the UE, the UE transmits the first report on one UL resource among the set of UL resources, and/or if the UE does not receive the type-1 UL configured grant configuration for the set of UL resources for transmitting the first report triggered by the UE, the UE transmits the request in response to the triggering of the first report.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) trigger a first report in response to a first condition being fulfilled; (ii) transmit a request in response to the triggering of the first report; (iii) receive a first DCI scheduling a first PUSCH; (iv) determine whether to transmit the first report on the first PUSCH based on whether a CSI request field in the first DCI indicates a first code-point which is associated with a first CSI triggering state associated with a first CSI report configuration for the first report; and (v) transmit the first report on the first PUSCH if the CSI request field in the first DCI indicates the first code-point.

Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two.

A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
triggering a first report in response to a first condition being fulfilled;
transmitting a request in response to the triggering of the first report;
receiving a first Downlink Control Information (DCI) scheduling a first Physical Uplink Shared Channel (PUSCH);
determining whether to transmit the first report on the first PUSCH based on whether a Channel State Information (CSI) request field in the first DCI indicates a first code-point which is associated with a first CSI triggering state associated with a first CSI report configuration for the first report; and
transmitting the first report on the first PUSCH if the CSI request field in the first DCI indicates the first code-point.

2. The method of claim 1, wherein if the CSI request field in the first DCI does not indicate the first code-point, the UE does not transmit the first report on the first PUSCH.

3. The method of claim 1, wherein:
the request is configured dedicatedly for the first report triggered by the UE, and/or
the request is not associated with any logical channel, and/or
the request is triggered without being associated with Buffer Status Reporting (BSR), and/or
the request is not associated with a Random Access Channel (RACH) configuration, and/or
the request is or corresponds to a Scheduling Request (SR).

4. The method of claim 1, wherein:
before transmitting the request, the UE does not expect to receive a DCI with the CSI request field indicating the first code-point, and/or
if the UE does not trigger the first report, the UE does not expect to receive the DCI with the CSI request field indicating the first code-point, and/or
the first code-point is configured with a single CSI report configuration.

5. The method of claim 1, wherein:
the UE receives a second configuration for configuring association between the first CSI triggering state and the first CSI report configuration, wherein the first CSI report configuration is associated with the first report triggered by the UE, and/or
the second configuration also provides association between a second CSI triggering state and a second CSI report configuration, and/or
the second CSI report configuration is for a second report triggered by a network node, and/or
based on absence of one parameter associated with the second CSI report configuration, the UE determines that the second CSI report configuration is for a second report triggered by the network node, and/or
based on the one parameter indicating information of aperiodic, periodic, or semi-persistent, the UE determines that the second CSI report configuration is for a second report triggered by the network node.

6. The method of claim 5, wherein the UE receives a second DCI scheduling a second PUSCH, and transmits the second report on the second PUSCH in response to the CSI request field in the second DCI indicating a second code-point which is associated with the second CSI triggering state.

7. The method of claim 1, wherein:
one parameter associated with the first CSI report configuration is used to indicate or configure that the first CSI report configuration is for the first report triggered by the UE, and/or
based on presence of the one parameter associated with the first CSI report configuration, the UE determines that the first CSI report configuration is for the first report triggered by the UE, and/or
based on the one parameter indicating information of UE-initiated reporting, the UE determines that the first CSI report configuration is for the first report triggered by the UE.

8. The method of claim 1, wherein:
the UE determines whether the first CSI report configuration is for the first report triggered by the UE based on whether the first CSI report configuration is associated with information associated with an event or a condition and/or based on whether the first CSI report configuration is associated with one or more candidate Reference Signals (RSs) corresponding to one or more candidate beams, and/or
based on the first CSI report configuration is associated with the information associated with the event or the condition and/or based on whether the first CSI report configuration is associated with the one or more candidate RSs corresponding to the one or more candidate beams, the UE determines that the first CSI report configuration is for the first report triggered by the UE.

9. The method of claim 1, wherein:
the UE receives a configuration of the first condition to trigger the first report by the UE, wherein the first report is a Layer 1 (L1) report, and/or
the first report corresponds to one kind of Uplink Control Information (UCI).

10. The method of claim 1, wherein the first condition includes any one of:
quality of one or more candidate beams is with an offset better than a quality of a current beam, and
the UE determines the quality of the current beam based on measurement of a first RS and determines the quality of the one or more candidate beams based on measurement of one or more candidate RSs, and
the quality corresponds to L1-Reference Signal Received Power (RSRP).

11. The method of claim 1, wherein:
if the UE receives a type-1 Uplink (UL) configured grant configuration for a set of UL resources for transmitting the first report triggered by the UE, the UE transmits the first report on one UL resource among the set of UL resources, and/or
if the UE does not receive the type-1 UL configured grant configuration for the set of UL resources for transmitting the first report triggered by the UE, the UE transmits the request in response to the triggering of the first report.

12. A User Equipment (UE), comprising:
a memory; and
a processor operatively coupled with the memory, wherein the processor is configured to execute a program code to:
trigger a first report in response to a first condition being fulfilled;
transmit a request in response to the triggering of the first report;
receive a first Downlink Control Information (DCI) scheduling a first Physical Uplink Shared Channel (PUSCH);
determine whether to transmit the first report on the first PUSCH based on whether a Channel State Information (CSI) request field in the first DCI indicates a first code-point which is associated with a first CSI triggering state associated with a first CSI report configuration for the first report; and
transmit the first report on the first PUSCH if the CSI request field in the first DCI indicates the first code-point.

13. The UE of claim 12, wherein:
the request is configured dedicatedly for the first report triggered by the UE, and/or
the request is not associated with any logical channel, and/or
the request is triggered without being associated with Buffer Status Reporting (BSR), and/or
the request is not associated with a Random Access Channel (RACH) configuration, and/or
the request is or corresponds to a Scheduling Request (SR).

14. The UE of claim 12, wherein:
before transmitting the request, the UE does not expect to receive a DCI with the CSI request field indicating the first code-point, and/or
if the UE does not trigger the first report, the UE does not expect to receive the DCI with the CSI request field indicating the first code-point, and/or
the first code-point is configured with a single CSI report configuration.

15. The UE of claim 12, wherein:
the UE receives a second configuration for configuring association between the first CSI triggering state and the first CSI report configuration, wherein the first CSI report configuration is associated with the first report triggered by the UE, and/or
the second configuration also provides association between a second CSI triggering state and a second CSI report configuration, and/or
the second CSI report configuration is for a second report triggered by a network node, and/or
based on absence of one parameter associated with the second CSI report configuration, the UE determines that the second CSI report configuration is for a second report triggered by the network node, and/or
based on the one parameter indicating information of aperiodic, periodic, or semi-persistent, the UE determines that the second CSI report configuration is for a second report triggered by the network node.

16. The UE of claim 15, wherein the UE receives a second DCI scheduling a second PUSCH, and transmits the second report on the second PUSCH in response to the CSI request field in the second DCI indicating a second code-point which is associated with the second CSI triggering state.

17. The UE of claim 12, wherein:
one parameter associated with the first CSI report configuration is used to indicate or configure that the first CSI report configuration is for the first report triggered by the UE, and/or
based on presence of the one parameter associated with the first CSI report configuration, the UE determines that the first CSI report configuration is for the first report triggered by the UE, and/or
based on the one parameter indicating information of UE-initiated reporting, the UE determines that the first CSI report configuration is for the first report triggered by the UE.

18. The UE of claim 12, wherein:
the UE determines whether the first CSI report configuration is for the first report triggered by the UE based on whether the first CSI report configuration is associated with information associated with an event or a condition and/or based on whether the first CSI report configuration is associated with one or more candidate Reference Signals (RSs) corresponding to one or more candidate beams, and/or
based on the first CSI report configuration is associated with the information associated with the event or the condition and/or based on whether the first CSI report configuration is associated with the one or more candidate RSs corresponding to the one or more candidate beams, the UE determines that the first CSI report configuration is for the first report triggered by the UE.

19. The UE of claim 12, wherein:
the UE receives a configuration of the first condition to trigger the first report by the UE, wherein the first report is a Layer 1 (L1) report, and/or
the first report corresponds to one kind of Uplink Control Information (UCI).

20. The UE of claim 12, wherein:
if the UE receives a type-1 Uplink (UL) configured grant configuration for a set of UL resources for transmitting the first report triggered by the UE, the UE transmits the first report on one UL resource among the set of UL resources, and/or
if the UE does not receive the type-1 UL configured grant configuration for the set of UL resources for transmitting the first report triggered by the UE, the UE transmits the request in response to the triggering of the first report.
